(19) United States
(12) Patent Application Publication
(10) Pub. No.: US 2015/0273345 A1
(43) Pub. Date: Oct. 1, 2015

(54) SYSTEMS AND METHODS FOR PLAYING A FANTASY LEGEND GAME

(71) Applicant: MATTHEW E. FORD, West Milford, NJ (US)

(72) Inventor: MATTHEW E. FORD, West Milford, NJ (US)

(21) Appl. No.: 14/230,680

(22) Filed: Mar. 31, 2014

(51) Int. Cl. A63F 13/828

(52) U.S. Cl. CPC A63F 13/828

(57) ABSTRACT

Systems and methods of selecting legend players in a processor based sports fantasy legend game are described. The system can be a web based server that provides processors that implement all of the methods described herein. In accordance with one method described herein, a user selects a complete fantasy legend sports team with at least one legend player that is entered by the processor. The processor determines a team score that is based on a performance of the legend player in a game played in the past. The game in the past is selected by the processor from a plurality of games based on a random number. The processor enables the user to review the performance of the legend player and to have the processor select a new game played in the past or have the user select a new legend player. The selected players in the fantasy legend game may all be legend players.

### BACKGROUND

Fantasy sports games, such as fantasy football, baseball, hockey, and soccer are played on-line, often in leagues, wherein a user creates a fantasy team which may compete with other fantasy games in a fantasy league. A fantasy team in a sport, in its present most used form, often includes players that are based upon real-life players who are active players in the sport.

Current sports, especially for professional players, are closely followed by the media. Data that describe a performance of a player during a game is recorded almost immediately and is available to fantasy game players in almost real-time. This allows a fantasy game to be played concurrently with a real game wherein the real-life players participate and to apply the performance of the real-life player to a scoring of the fantasy game. A scoring of the fantasy game can take place during the playing of the real-life game or shortly after the real-life game has finished.

People sometimes speculate how a sports team would perform in an actual game if a legendary player of the sport who is no longer active in the sport would have been part of the team. Such an inactive real-life player who may be legendary is called a legend or a legend player herein.

It is believed that no on-line fantasy sport games are available to fantasy sport game players that enable to include a legend player on a team in a fantasy game.

Accordingly novel and improved methods and systems for fantasy game playing are required that include a legend player.

### SUMMARY OF THE INVENTION

In accordance with one or more aspects of the present invention methods and systems to play a fantasy legend game for a sport on a computer are provided wherein the legend is a player in the sport who has a performance record in a played game in the past.

In accordance with an aspect of the present invention, a method for playing a fantasy legend game in a sport by a user is provided, comprising a processor on a server computer providing to a player of the fantasy legend game a menu on a display of a client computer to draft for a fantasy legend team a plurality of players that includes at least one legend player from a list of a plurality of legend players stored in a memory, wherein each legend player is a player with a record of a plurality of played games in the past; the processor accepting the at least one legend player selected on the menu; the processor determining that a complete fantasy legend team has been selected in accordance with a rule of the fantasy legend game; the processor assigning a score to the complete fantasy legend team, based on at least an individual score of the at least one legend player, wherein the individual score of the at least one legend player is determined from a performance of the at least one legend player in a game in the plurality of played games in the past, wherein the game in the plurality of played games in the past is selected by the processor from the plurality of played games by applying a random number.

In accordance with another aspect of the present invention, a method for playing a fantasy legend game in a sport by a user is provided, wherein the complete fantasy legend team includes players who are active as professional players in the sport.

In accordance with yet another aspect of the present invention, a method for playing a fantasy legend game in a sport by a user is provided, further comprising: the processor, before a winner of the fantasy legend game is determined, determining and displaying on a display the individual score of the at least one legend player and enabling a swapping of the individual score by selecting a new scoring game.

In accordance with yet another aspect of the present invention, a method for playing a fantasy legend game in a sport by a user is provided, further comprising: the processor requiring a compensation from the user before the individual score is provided.

In accordance with yet another aspect of the present invention, a method for playing a fantasy legend game in a sport by a user is provided, wherein the processor enables a single swapping.

In accordance with yet another aspect of the present invention, a method for playing a fantasy legend game in a sport by a user is provided, wherein the fantasy legend team includes at least two legend players and the processor is configured to perform a swapping of the at least two legend players.

In accordance with yet another aspect of the present invention, a method for playing a fantasy legend game in a sport by a user is provided, further comprising: the processor enabling the user to instruct the processor to generate a new individual score of the at least one legend player that is determined from a performance of the at least one legend player in another game played in the past.

In accordance with yet another aspect of the present invention, a method for playing a fantasy legend game in a sport by a user is provided, wherein the random number is generated by a random number generator with a uniform probability distribution.

In accordance with yet another aspect of the present invention, a method for playing a fantasy legend game in a sport by a user is provided, wherein each member of the complete fantasy legend team is a legend player.

In accordance with yet another aspect of the present invention, a method for playing a fantasy legend game in a sport by a user is provided, wherein at least one member of the complete fantasy legend team is a legend player in a flex position, wherein the flex position is a team position selected from a plurality of eligible team positions.

In accordance with yet another aspect of the present invention, a method for playing a fantasy legend game in a sport by a user is provided, wherein a salary cap for the fantasy legend game is related to a number of legend players in the complete fantasy legend team.

In accordance with yet another aspect of the present invention, a method for playing a fantasy legend game in a sport by a user is provided, wherein the salary cap is modified by the processor in response to the user paying an amount of money.

In accordance with yet another aspect of the present invention, a method for playing a fantasy legend game in a sport by a user is provided, wherein the user is part of a plurality of users, each of the plurality of users paying a fee to participate in the fantasy legend game.

In accordance with yet another aspect of the present invention, a method for playing a fantasy legend game in a sport by a user is provided, wherein a portion of the paid fee is awarded to a winner of the fantasy legend game.

In accordance with yet another aspect of the present invention, a method for playing a fantasy legend game in a sport by a user is provided, wherein the fantasy legend game is selected from the group of sports consisting of football, basketball, baseball, ice hockey, golf and car racing.

In accordance with yet another aspect of the present invention, a method for playing a fantasy legend game in a sport by a user is provided, wherein the fantasy legend game is selected from the group of sports consisting of soccer, cricket, field hockey and horse racing.

In accordance with a further aspect of the present invention, a system to play a fantasy legend game in a sport by a user is provided, comprising: a memory, configured to store and retrieve data, including instructions; a processor, configured to retrieve instructions from the memory to perform the steps: providing to a player of the fantasy legend game a menu on a display of a client computer to draft for a fantasy legend team a plurality of players that includes at least one legend player from a list of a plurality of legend players stored in a memory, wherein each legend player is a player with a record of a plurality of played games in the past; accepting the at least one legend player selected on the menu; determining that a complete fantasy legend team has been selected in accordance with a rule of the fantasy legend game; assigning a score to the complete fantasy legend team, based on at least an individual score of the at least one legend player, wherein the individual score of the at least one legend player is determined from a performance of the at least one legend player in a game in the plurality of played games in the past, wherein the game in the plurality of played games in the past is selected from the plurality of played games by applying a random number.

In accordance with yet a further aspect of the present invention, a system is provided, wherein the complete fantasy legend team includes players who are active as professional players in the sport.

In accordance with yet a further aspect of the present invention, a system is provided, further comprising: the processor, before a winner of the fantasy legend game is determined, determining and displaying on a display the individual score of the at least one legend player and enabling a swapping of the individual score by selecting a new scoring game.

In accordance with yet a further aspect of the present invention, a system is provided, further comprising: the processor requiring a compensation from the user before the individual score is provided.

The present invention makes playing a fantasy game much more appealing, interesting and exciting.

### DESCRIPTION OF DRAWINGS

FIG. 1 illustrates a networked fantasy legend system in accordance with an aspect of the present invention.

FIG. 2 illustrates a computing system used in the system for selecting a sport in accordance with an aspect of the present invention.

FIG. 3 illustrates a system that performs a fantasy sport's draft in accordance with one or more aspects of the present invention.

FIG. 4 illustrates a system that performs a fantasy's legend sport draft in accordance with one or more aspects of the present invention.

FIG. 5 illustrates a system that performs a legend player's swap in accordance with one or more aspects of the present invention.

FIG. 6 illustrates a computing device to perform instructions in accordance with various aspects of the present invention.

FIG. 7, FIG. 8 and FIG. 9 illustrate a roster for various sports in accordance with one or more aspects of the present invention;

FIG. 10 illustrates a user interface for a fantasy legend game in accordance with one or more aspects of the present invention;

FIG. 11 illustrates a swap in accordance with an aspect of the present invention;

FIGS. 12, 13, 14, 15, 16, 17, 18 and 19 illustrate a roster of football legend players from which a player is drafted in accordance with an aspect of the present invention;

FIG. 20 illustrates a scoring rule for a fantasy legend football game in accordance with an aspect of the present invention;

FIGS. 21, 22 and 23 illustrate a roster of hockey legend players from which a player is drafted in accordance with an aspect of the present invention;

FIG. 24 illustrates a scoring rule for a fantasy legend hockey game in accordance with an aspect of the present invention;

FIGS. 25, 26 and 27 illustrate a roster of baseball legend players from which a player is drafted in accordance with an aspect of the present invention;

FIG. 28 illustrates a scoring rule for a fantasy legend baseball game in accordance with an aspect of the present invention;

FIGS. 29 and 30 illustrate a roster of basketball legend players from which a player is drafted in accordance with an aspect of the present invention;

FIG. 31 illustrates a scoring rule for a fantasy legend basketball game in accordance with an aspect of the present invention;

FIG. 32 illustrates a roster of legend car drivers from which a driver is drafted in accordance with an aspect of the present invention; and

FIG. 33 illustrates a scoring rule for a fantasy legend car race game in accordance with an aspect of the present invention.

### DESCRIPTION

Fantasy games are often played on a computer system with multiple computing devices that are at least partially networked. While specific embodiments are disclosed of systems and methods, the invention is intended to extend to its broadest aspects. Thus, if limiting language is used when describing an embodiment that language is not intended to limit the broad aspects of the various inventions described herein.

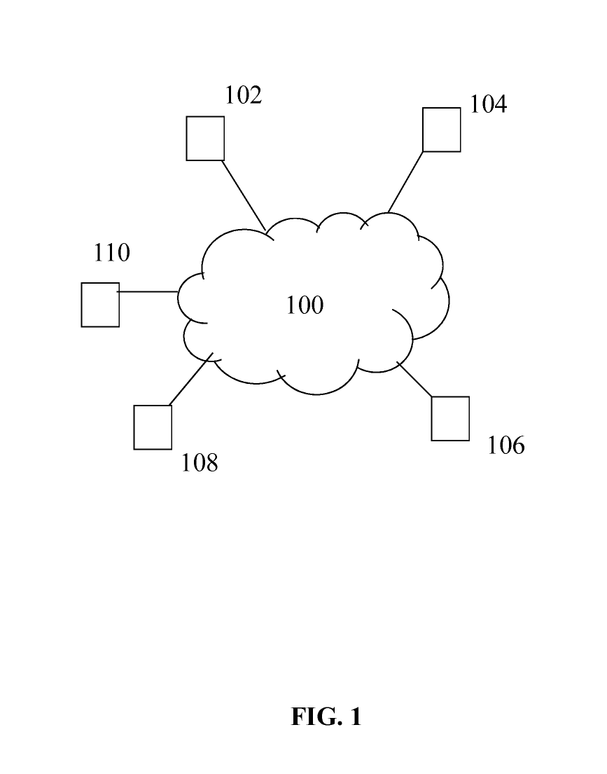

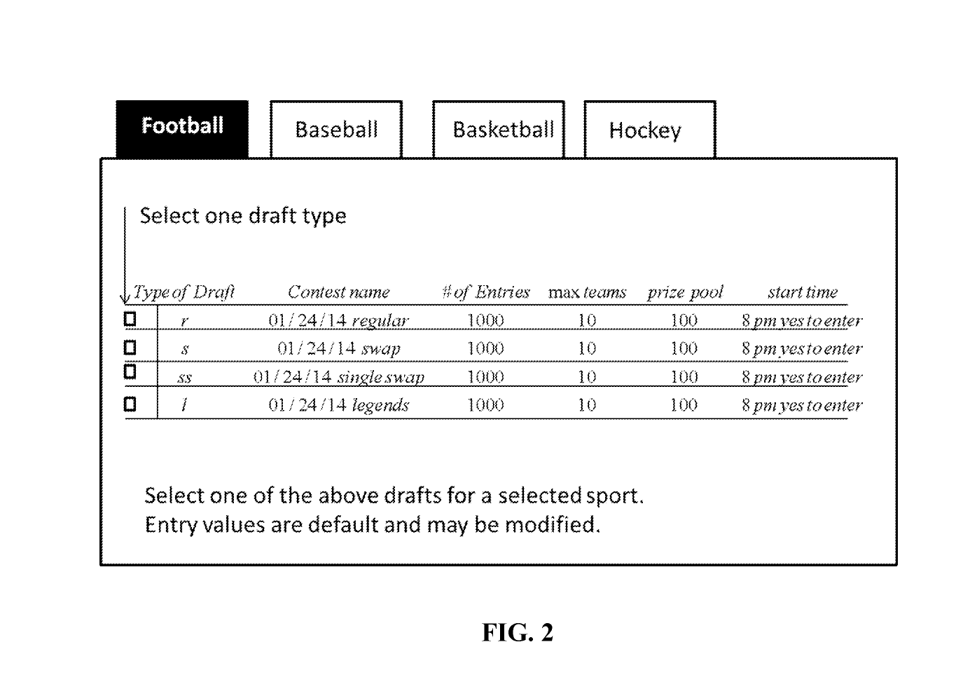

FIG. 1 illustrates a networked system in accordance with an aspect of the present invention. A network 100 connects a plurality of computing devices. A network may be the Internet, a local area network, a public phone network, a wireless network or any other network or combination of networks that connects two or more computing devices.

A computing device is a device with a processor or other circuitry that is configured to execute instructions. A computing device also has memory or other data storage means to store and retrieve data. A computing device as disclosed herein also has communication circuitry to connect to a network. A computing device operated as a client also has an input device such as voice, camera, touch screen, a mouse or a key-board and an output device such as a display screen. Examples of computing devices are a personal computer, a laptop computer, a server, a tablet computer, a smartphone and a portable phone.

FIG. 1 shows a client computing device 102 connected via a network 100 to a server 104. The computing device 102 may be used by a first user participating in a fantasy legend game that is hosted on server 104. A client computing device 106 is connected to the network 100 to communicate with server 104 for a second user to participate in a fantasy legend game. The first and the second user will sign-up to the server with different log-ons.

A client computing device 108 may communicate with the server 104 for managing one or more functions of the server. A separate computing device 110 which may be a server or a client, may provide to server 104 real-time or updated data related to ongoing real-life games or real-life games that have been finished recently. A server 110 may also be configured to store and provide performance data of a team, a coach, and of individual players, including historical data.

The non-legend players in a fantasy legend team are current or real-life players, and in one embodiment of the present invention are professional game players.

Historical performance data may be organized and accessed related to a specific game of a coach, team or player. This includes historical performance data of a last completed game. Historical performance data may be organized and accessed related to a season. Historical performance data may also be organized and accessed related to a multi-season period or related to a career performance when it pertains to individuals or coaches.

The outcome of a fantasy sports game is generally determined by an actual real-life performance of a player that is part of the fantasy game team. The team is organized or drafted by the fantasy game player. In a fantasy legend game, a legend player is drafted for the fantasy team in accordance with an aspect of the present invention. A legend player, as the name suggests, is a player with a performance reputation. The legend player in accordance with an aspect of the present invention, may be a living legend. A living legend has a recorded performance history for one or more games played in the past. A performance rating of the living legend player for each of the played games that can be applied for a score calculation in a fantasy legend game of that living legend player is available.

The “living” aspect of the “living legend player” refers to the fact that the player is still active in the sport. An example of a “living legend player” in football is quarterback (QB) Peyton Manning, who was an active player in the 2013/2014 season. Mr. Manning, of course, has also a well documented record of played games. In accordance with an aspect of the present invention, Peyton Manning can be drafted for a fantasy football game as a QB as a real-life player. His score as a real-life draft will be calculated on a performance of a real-life game.

In a fantasy legend game, Peyton Manning may be drafted as a legend player. That is: his performance will be determined by a game that was played in the past and of which the outcome is known. How such a game is selected is explained further below.

In a mixed mode of a fantasy legend game, real-life players and legend players are drafted and a score is determined based on a real-life performance of the real-life player and a past performance of the legend player. In accordance with an aspect of the present invention a named player may be drafted as a real-life player and as a living legend player for a team.

A legend player may also be an inactive or retired player for whom a game record exists. That player does of course not participate in a real-life game anymore and only past games can be selected for scoring in a fantasy legend game. Accordingly, a retired or inactive legend player, in accordance with an aspect of the present invention, can only be drafted in a game that enables drafting of legend players.

In accordance with an aspect of the present invention, a legend player, is a player with a track record of played games for which a score can de derived. In accordance with an aspect of the present invention, a legend player has a track record of at least 10 played games. In accordance with an aspect of the present invention, a legend player has a track record of at least two seasons of game play.

The term “legend” of course suggests a level of performance or excellence. However, current definitions provided herein make a legend player a player with a track record and no required level of performance. In accordance with an aspect of the present invention, a top legend player is a legend player with at least one played game wherein the legend player achieved a score that is in a defined class of performance. The defined class may be a top 25% performance rating of all players in a similar position in the sport during a season, during a defined period, or during an active career, during a career with a specific team, or any variation thereof. The class may contain a broader performance rating, such as 50% or a smaller one, such as 10% or 5%. It should be clear that if the class is smaller, with a rating calculated over a longer period, then the legend player will have a higher salary than from a broader class.

For instance a legend player who has been in the top 10% of performance rating during a career period of 10 years, may be considered a better top legend player than a player who was rated in the top 50% performance rating during one season.

In accordance with an aspect of the present invention a top legend player is a legend player with a performance rating that is at least determined to be in a top 50% rating over at least one season of a plurality of games. One can make the rating class smaller (like top 25%, 10%, 5%, 1%) and/or the period of determining the rating longer (two seasons, 5 seasons, 10 year period, entire career, entire professional career, entire professional career with at least one team).

The above aspects are believed to be different from existing fantasy sports games. For that reason, a fantasy sports game provided in accordance with one or more aspects of the present invention is called a fantasy legend game, and always includes at least one legend player. A historical, no longer active, player is called a retired legend player herein. A legend player who still plays real-life games is called a living legend herein.

In accordance with an aspect of the present invention a real-life player is designated to be a legend player or to play in a legend mode. In that case the score of the real-life player in legend mode is determined from one or more previously played games which is determined by applying a random number generator. It is emphasized that fantasy sports game herein have at least two phases: 1) a draft phase, wherein a team is assembled; and 2) a scoring phase, wherein a score of a team is based strictly on a rating of an actual performance of the team members in one specific game or in another embodiment of the present invention based on two or more specific games. The actual scoring thus depends on an actual performance of a player during one or more games. It will be provided in accordance with an aspect of the present invention, how a fantasy legend player can change the selection of the one or more games that determine a score of a legend player. However, the fantasy legend game player is unable to influence the score of a selected game or of selected one or more games. This is different from video games wherein a player in a game is at least partially controlled by the game player.

In accordance with an aspect of the present invention a game in a sport has a scoring system that determines a rating of the game. In accordance with an aspect of the present invention a player participating in a game is scored using objective scoring rules. This means that verifiable achievements are rated in a repeatable way and rating by different people using the same rule would lead to identical scores or almost identical scores within a margin of error of preferably 10% and more preferable within a margin of error of 5%.

In accordance with an aspect of the present invention each sport may have different scoring rules, however the scoring rules within a sport will lead to comparable scores of players in comparable playing positions.

In one embodiment of the present invention historical performance data is organized and can be accessed in accordance with external conditions. For instance, overall performance per game or over a number of games can be organized and accessed based on weather conditions. So, an actual game for scoring is selected based on the actual weather conditions during that game. Weather conditions can be rated and sorted based on aspects of the weather, such as temperature, rain, snow, and wind.

Accordingly, when a roster is assembled for a fantasy game that is played in conjunction with a real-life game expected to have very cold weather conditions, a player of the fantasy game in accordance with one or more aspects of the present invention may search a database stored on 110 for active or legend players who perform very well under cold conditions.

In accordance with an aspect of the present invention, a player's, team's and coach's performance may be organized and accessed on a database in accordance with an opponent. An opponent may be a specific player or a team.

In accordance with an aspect of the present invention one can access performance data of a player with a performance rating based on an opponent rating. For instance, one may find a series of performance ratings of a football quarterback against different opponents with defense ratings.

Other ratings schemes are contemplated and may be applied for instance to select a game that determines a performance and scoring of the legend player.

In a fantasy legend game a team with at least one team including a legend player is drafted and created on a computing device including from data provided by a server by a logged-on fantasy legend game player. The at least one team will play against another team on a computing device. There are different ways the assembled team with the legend player can play against another team in accordance with one or more aspects of the present invention. However, prior to playing a game on the computer teams have first to be created or drafted.

A fantasy legend game player who is logged on to the fantasy legend game server selects a type of sport that he or she would like to create a player or a team for to play against at least one other player or team on the fantasy legend game server. Illustrative sports that can be selected include football, baseball, basketball, ice hockey, field hockey, soccer, golf, rugby, volleyball, cricket, surfing, car racing, boat racing, horse racing or any other sport that has competing participants of which a performance can be rated and used to play a fantasy game.

In one embodiment of the present invention a fantasy legend game is hosted on a server that is based on Nascar/Indy car racing, and/or on games played in the National Football League (NFL), and/or in the National Basketball Association (NBA), and/or the National Hockey League (NHL), and/or Major League Baseball (MLB) and/or any competitive game played in College Sport and of which games are rated in performance of players. A fantasy legend player can play alone, for instance with an assembled or drafted team against a second assembled or drafted team assembled by the fantasy legend player, or against a team assembled by the computer or against a team that is assembled by a different fantasy game player on the server. One may play multiple games against the same or different teams, for instance organized in a league to play a league multi-game contest. Other contests which include the assembled fantasy legend team are fully contemplated.

In one embodiment of the present invention one type of contest includes the Legendary Crossover, which may also be named True Fantasy. The user/player selects one of the following players from each of the corresponding sports, One Quarter Back, Pitcher, Point Guard, Center (NHL), Running Back, Infielder, Shooting Guard, Wing (NHL), Wide Receiver, Outfielder, Forward or Center (NBA), Defensemen or Goalie (NHL), plus Any Position Player that the user chooses but is limited to ONE Legend per sport from the NFL, NBA, MLB, and NHL so 16 LEGENDS in total. This will also be one of first Big Draw Games, but it too can be played every day and has multiple versions such as the same format but pick any three Legends from any of the four major sports. In one embodiment of the present invention a lesser scale version of the above is provided.

In one embodiment of the present invention a Seasons of Legends is provided which is much like a Legend's Showdown and will be able to be played all year long as it does not depend on actual real-life games going on. This is a statistical season draft where users can choose the Legends for all slots on their team. These games will last 24 hours or less and have small draft rooms between 2-100 entrants. Users can almost choose an entire team such as the 1986 Bears starting line up of, QB, RB, WR, WR, TE, FLEX, D, K to face some of the players from the 1974 Steelers team in a Legendary Team Draft as well. In one embodiment of the present invention, a user is not able to move any players. The players stats would be randomly chosen based on a random number. In this embodiment, the user can have players from the 1986 Mets squad versus some of the players from the 2013 Boston Red Sox, the possibilities are endless. Within this contest embodiment hosted on the server each Legend on each team would not play the same week as one another unless the program randomly selected it, but because a random game generator (RGG) counts Legends picks as an overall total for the site, not per draft, the Legends games are truly random. So even if Terry Bradshaw was in the same line up as Lynn Swan they would not be playing the same week, thus taking away the possibility of a user rigging the system.

In what type of contest the assembled fantasy legend team will play is selected by the fantasy legend game player as the Contest Mode.

A contest can be a single game following a single draft. A contest can also last several games, using different opponents in a league, and may last a complete season.

In accordance with various aspects of the present invention the playing of a fantasy legend game on a server is made more exciting by allowing a player to obtain a reward by winning one or more games played by the team with a legend player assembled by the fantasy legend game player. A player may be required to pay an entry fee to be authorized to play the fantasy legend game on the server. A fantasy legend game player may be allowed to improve chances to win a game by accessing certain information or by selecting a certain type of player or by getting an improved position in selecting from a limited pool of players.

Payment by a fantasy legend game player to improve a chance to win a game may be done in real money, or by buying virtual money, points or scrip that can be applied to access information, improve drafting position or otherwise to improve a chance to win a game.

A fantasy legend game player can sign up for playing a fantasy legend game by connecting to a server via a network, providing at least some identifying data such as User Name and Password and obtaining a link to which the player can connect to select a sport and to initiate and to play the game, including paying an entry fee.

For illustrative purposes the following steps of playing a fantasy legend game are illustrated for the sport of football in order to provide consistent examples. It is to be understood that the steps and systems provided in accordance with various aspects of the present invention can be applied to different sports and that football is used herein for illustrative purposes only.

In one embodiment of the present invention a real-life player, for instance when being injured or having a bad season or for other reasons, can be made a legend player by allowing a fantasy legend player to select a game for determining a score from a previous season. This can be achieved by the fantasy legend player selecting a legend mode for a player who is currently still active in the sport.

In one embodiment of the present invention, a fantasy legend game is played off-season or not concurrent with or prior to a game that determines a player's score. The whole game will in that case be played in legend mode and the system, for instance by way of a random number generator selects a game played by a legend player who may be still a real-life player, who at that time will be considered a living legend. This allows a fantasy game to be played during off-season or during any period that no real-life competition is going on.

In one embodiment of the present invention an administrator of the fantasy legend game decides from which group of games the scoring game is selected, which is displayed on the screen. In another embodiment of the present invention, a fantasy legend game player can decide a group of games from which the scoring game is selected, for instance under a condition of paying a fee.

In order to play a game by the player, a team has to be assembled which is called a draft. The player is directed to a web page called a Draft List. The draft list shows at least 5 types of games: All, Regular, legends, Swap, Single Swap, and Add Player.

A fantasy legend game as provided herein in accordance with various aspects of the present invention can be compared to adding a rear view mirror to the machine that is fantasy sports and that allows the fantasy legend game players to use legends either from the past or current Legendary type players as well. In one embodiment of the present invention in a Swap & Add fantasy legend game the players themselves will be able to swap in or Add any player from any position at all to either their FLEX position for Football or the UTIL position for all other sports (which is believed not to be done in any other current fantasy sports play). Several types of swaps are provided in accordance with various aspects of the present invention. There is a single swap, allowing a swap of one player or position, a double swap, allowing a swap of two players or positions, a triple swap allows swapping of up to three positions of the regular players list for legends and there is an unlimited swap allowing to swap all positions.

One may also provide a limit on the number of times that a player in a defined position may be swapped. In one embodiment only a one time swap is allowed, in another embodiment up to two times, in yet another embodiment up to three times, etc.

Each draft on the draft list includes the following fields: Sport (the selected sport, football in the illustrative example), Draft Name ( ), Code (i.e. NFLSS01), Entrants vs. Available Spots ( ), Entry Fee, Prize Pool, Start Time, Link to Enter.

The fantasy legend game in one embodiment of the present invention provides a game menu with different selections. Herein, Sport is a simple pick of which sport the player would like to participate in. Draft Name will have a guide to show what style of draft or game that the player is drafting for. Entrants will have a list on each and every draft of just how many entries are allowed in total and how many multiple entries are allowed from each individual player. Games may be hosted with multiple entries to allow the user a better percentage of winning Available sports will be all sports that are enabled on the host and include football, baseball, basketball, hockey, college, golf, soccer, and racing.

Racing may include but is not limited to car racing, boat racing, airplane racing, bicycle racing, motor bike racing, surf board racing, ski racing, ski board racing, speed skating, sled racing, running, swimming, or any combination thereof.

Entry Fee will breakdown what every entry fee is for whichever contest of skill the player decides to play in. A Prize Pool is the amount of money or prize itself given to the winner of each and every game we host, winners will be posted on our site to show all who won which contest. A Start Time is given to allow each player when the contest will begin as a way to help the players be ready. Link to Enter is a Link to enter whichever contest the player chooses to participate in.

The draft list page may include one or more filters, which limits the selection on a draft page. For instance one may select Sport=Football as a filter to limit all possible selections to the sport of football. Other filters may be Entry Fee (range) and Prize (range).

In order to form a team a fantasy legend game player has to form a team by a draft. The draft is the start of the game as the selection of players in the team will determine a win or lose outcome. Each draft game has the following fields:

1) Code; automatically generated
2) Entry Fee; fee payable by fantasy legend game, where monies go to the prize pool and hosting fees.
3) Sport; football in the example
4) Available Entrants; each contest may have a max number of entrants allowed to play

### 5) Total Entrants;

6) Number of Entries allowed per player;

### 7) Prize Pool;

### 8) Start Date;

9) Draft Type; this is the breakdown for the user to direct themselves into which draft type they would like to play, for example. Swap, Legends, Add a player game modes discussed earlier.

The Draft Types are set within the client's system. Each draft type comes with certain preset variables including:

1) Available positions—this is a conditional field dependent on the selected Sport and Draft Type; (examples are Quarterback, Running Back, etc, in football)

### 2) Sport;

3) Contest Description (text);
4) Contest Rules and Prizes (text);
5) Binary—Whether a player can more salary cap space (and amount of cap space/cost)
6) Legend Game Variation, which may include:
a) Regular Draft wherein only current sports players are available to draft;
b) Swap: one position can de drafted from a Legends list. In one embodiment of the present invention the Legend's performance statistics (stats) are randomly generated from a single game played over the course of the Legend's career. The fantasy legend game player is allowed to pay an additional credit to swap out a different legend into that position or have another game's stats randomly generated. The fantasy legend game player can swap an unlimited number of times, but may be required to pay for every swap, for instance $1 per swap.
c) Single Swap, which is similar to the above Swap except that the fantasy legend game player can only swap once.
d) Add Player. The team has a full roster of current real-life players plus an additional flex position to be filled by a Legend.
e) Legends, wherein a full roster is filled by Legend players.

There are different types of random generators. Random generators implemented on a processor may strictly speaking be a pseudo-random number generator. However, for the purpose of the steps provided herein in accordance with one or more aspects of the present invention, a processor implemented random number generator, as for instance programmed in Java and as applied for a number of games, will appear to be random to a user. In one embodiment of the present invention a random number may be downloaded from a random number generating server.

At any rate, a random number generator applied herein will pertain for instance to a selection of games or other events. The number of games or events that a random number is applied to related to a specific legend player in one embodiment of the present invention will not exceed 100, in another embodiment of the present invention will not exceed 500, in yet another embodiment of the present invention will not exceed 1000, and in yet another embodiment of the present invention will not exceed 5000. For a selection of a game or event based on the random number generator, the probability distribution of generated numbers is uniform or substantially uniform and meets the statistical requirements for a uniform probability distribution for the number of drawings. The probability distribution is characterized by the probability density function (PDF) of a discrete uniform probability distribution.

In general a random generator implemented on a processor has a probability distribution. As an example, a random generator has a uniform or substantially uniform probability distribution. That is, the probability of a number that is generated is equal to the probability of any other number that is generated. As an example a random generator may generate pseudorandom numbers in an interval[0,1]. For instance 100 consecutive generated numbers would presumably be equally distributed over intervals of [0-0.1] (0.1-0.2] . . . (0.9-1.0] with about 10 numbers generated in each interval. Some intervals may have 12 or 13 numbers while others have perhaps 7 or 8 numbers. But repeating the experiment for 1000 generated numbers will approximate the uniform distribution even better. Statistical measures for a probability distribution such as mean, variance and the like are known to one of ordinary skill in the art and need no further explanation herein. Other types of probability distribution than a uniform probability distribution may also be applied.

Assume that in case of a uniform probability distribution an outcome is YES if the random generator generates a number smaller than for instance 0.5 and the answer is NO when the outcome is equal to or greater than 0.5. In that case the overall chance for YES and NO are equal (0.5). One can bias the chance to an outcome by selecting a different outcome interval. For instance one can take an interval between 0 and 0.7 as YES and between 0.7 and 1.0 as NO. The result is then biased towards YES.

In one embodiment of the present invention there is no bias in selecting a Legend game for applying stats to a Legend in a Swap. Each game has equal probability. That means that there is a chance to swap to a game wherein the Legend performed extremely well, for instance because the opposing team in that game was weak or disorganized or missed important players due to injuries. There is of course also a chance that one would swap to a game wherein the team performed very badly.

In accordance with an aspect of the present invention each game stored on a database on a server or each game that is enabled to be used in a fantasy legend game is provided with a rating. Such a rating can be in any desirable scale and it can be a single number or multi-dimensional. Different games may be rated with different rating scales or methods. In accordance with an aspect of the present invention a mechanism is provided that creates a common rating for all games. For instance, one game may be rated on a scale of 1 to 5, while another game is rated on a scale of 1 to 10, with a highest number in each scale reflecting the best performance and 1 reflecting the worst performance. One can make the 1 to 10 scale the common scale and convert the 1 to 5 scale to 1 to 10 by for instance multiplying the numbers 2 to 5 with 2 and leaving 1 unmodified.

In some cases, such as in football, a scale may be multi-dimensional, for instance 2-dimensional, by providing a number for offense performance and a number for defense performance. One may convert a multi-dimensional rating to a single number by for instance calculating the average of the multi-dimensional rating. Also more than 2 dimensional ratings may be applied, reflecting for instance performance of a special team, or of particular positions. One may convert a single number rating to a multi-dimensional one, by giving the single number rating to each dimensional rating, if so desired by applying also a weighting factor. Many rating systems are possible that can be calculated from available stats of a game. A server related to the fantasy legend game is configured to either calculate a rating for each game or apply existing ratings for each game or convert an existing rating of each game to a common rating applied by the fantasy legend game.

A legend game to determine an individual score of a legend for a fantasy legend game in one embodiment of the present invention is biased by external conditions, such as weather, a game season, an age of the legend player or any factor that would influence an individual score of the legend player. The game interface may provide a selection such as a season or age or age period or weather in which the legend played. The game may also bias the selection of the game towards certain conditions. For instance for a payment, the player of the fantasy legend game may select a class or external condition from which a game has to be selected. This forms an advantage for a fantasy legend game player who is very familiar with the legend player. For instance, the fantasy game player may want to select a game played in a season in 1995 or a range of seasons, or when the legend player was of an age of 31-33 years old. In the alternative, the selection of a game may be completely random over all the selectable games played by the legend player.

In one embodiment of the present invention the probability density function of the random number generator is not a uniform distribution but more of a binomial or normal distribution, reflecting a period of top performance and a starting and fade-out period that is given lesser weight in determining a game for an individual score of the legend player.

In one embodiment of the present invention the system may provide external conditions to the fantasy legend game: such as weather or a quality of the opposing team, for instance of the defense. Under the defined external conditions, it would make it more interesting for the fantasy legend game player to select a legend player or real-life player to make sure the selected player would perform well under the defined external conditions in the fantasy legend game.

An element that can be applied to select a legend game to determine a performance of a legend player in a fantasy legend game is to select a period or season for the legend player. For instance in one season the legend player may have been inconsistent with a few games of truly top notch and superior performance and with also several games of very bad performance. In another season, the performance of the legend player was consistently good. Not brilliant, but also not with many mistakes or bad performances. In a Swap, a fantasy legend game player may select or buy performance in a certain season of the legend player.

The client is to determine which of the variables as provided earlier above is controlled via the type of draft the player selects, and which are preset as part of the Draft type.

In one embodiment of the present invention, each draft by sport will have a preset template of positions which need to filled from the available players either active or legends. The following steps are to be executed

1) Admin selects Sport and Draft Type to be displayed in one embodiment; wherein the Admin may be the authorized host of the fantasy legend game.
2) Admin selects Entry Fee and Available Slots; for example a draft or game with 0/100 has one hundred spots or slots to fill.
3) Admin sets Draft Start Date/Time;
4) Site generates Available Positions and Prize Pool based on input (and embedded logic); The Prize Pool is a percentage of the amount to play in the contests that are hosted, for example if a player pays $22 to play then $20 of the $22 would go to the Prize Pool and $2 would go the host of the website.
5) Server generates List of Players (available to draft) based on data received from Client-side;
6) Site generates number of salary cap increases allowed (at 1 credit for 10,000 in salary cap).

In accordance with an aspect of the present invention the system provides a list of available players, including:

Shows all current players (or legends if applicable).

Fields shown: Position, Player Name, Opponent (game they are playing this week. Not applicable for Legends), Salary (pulled from client system), FPPG (pulled from client system). FPPG are points per game in real time for all current players brought to the hosted game by live feeds currently provided by for instance SportsData of Minneapolis/St. Paul and at the very end of the competition/contest for the Legends which their score is randomly selected by the RGG (Random Game Generator). The total of all determines the winner.

1) Tabs and filters: Position (tabs), Game (dropdown filter), Search field
2) User can add players to his lineup. System sums salary total against salary cap.
3) Export: player lists (as filtered/searched) can be exported
4) Import: lineups used in other Draft games can be imported
5) Submit Your Team: you can go back and edit until Game starts

A dedicated web page in the fantasy legend game is provided that provides Rules/Terms and Conditions for participating with the web site and for playing the fantasy legend game. This page will be linked from other pages and is linked in footer and from all Draft detail pages.

Another web page in the fantasy legend game is the My Account page, which is the landing page with links to settings, profiles, etc.

Another web page in the fantasy legend game is the Account Settings page that includes the possibility to edit the player's profile (Edit Profile).

Another web page in the fantasy legend game is the Profile page that includes details about the player and includes an email address.

Another web page in the fantasy legend game is the Transaction History page that includes all credit purchases and all credit withdrawals into cash.

Another web page in the fantasy legend game is the Buy Credits page.

Another web page in the fantasy legend game is the Checkout/Confirmation page.

Another web page in the fantasy legend game is the My Lineups page that includes the following information:

1) Shows all lineups the user has created
2) Filters: by Sport, Game Status (new, live, complete, etc)
3) Option to create new lineup (links to draft detail page)
4) Global Swap (swap out one player for another across multiple lineups)
5) link on each lineup to “edit”

Another web page in the fantasy legend game is the Lineup Detail page that is linked from an “edit” link on the “My Lineups” page.

Another web page in the fantasy legend game is the Draft Results List page that shows all Draft games that are completed or in progress.

Another web page in the fantasy legend game is the Drafts Results Detail page.

Another web page in the fantasy legend game is the Create Account page.

Another web page in the fantasy legend game is the About page.

Another web page in the fantasy legend game is the FAQ page.

Another web page in the fantasy legend game is the Forum List page.

Another web page in the fantasy legend game is the Forum Detail page.

Another web page in the fantasy legend game is the Contact Form page.

Another web page in the fantasy legend game is the Notification page which displays system notifications to the user, which must be defined.

The fantasy legend game also includes a set of administrative tools with as examples:

1) Draft (add/edit/delete)—some variables are controlled in CMS and some in the client system
2) Basic pages

### 3) Manage Forum

4) Manage Users (edit account details, ban users, view transactions, view drafts)
5) Transactions (e-commerce)—reporting on the following:
all Paypal transactions (money in/out)
all Credit transactions
export transactions to other file formats
all reporting have search fields and filters for date, user, transaction amount.

The above and FIG. 1 illustrates a computer and communication infrastructure that allows one or more remote players to communicate with a server to each play a fantasy legend game.

User Cases

Methods provided herein in accordance with various aspects of the present invention and implemented in instructions that are executed on a processor are illustrated in the following user cases combined with diagrams of screenshots that illustrate screens generated on a display in correspondence to steps in the fantasy legend game.

A system is configured to perform steps such as User Creates Account; User logs into system; user purchases credits; system directs a user to buy more credit; etc. While these system elements are significant, the actual fantasy game begins by selecting a sport and involves the selection or draft of one or more players to play the sport.

Regular Draft

A player of the fantasy game may select a regular draft for playing the fantasy game. The system provides the required template for this type of draft and the selected sport (for example football). Each draft type and sport has a team template which includes the correct number and type of positions that need to be filled. The number of positions to be filled in a fantasy game may be reduced compared to the actual size of a team in the real-life sport. In one example, in a football fantasy game only certain positions may be required to be filled and for instance none of the special team members and only a limited number of defense positions. Also all offense and all defense positions may be required to be filled. Or any combination of team positions may be required to be filled.

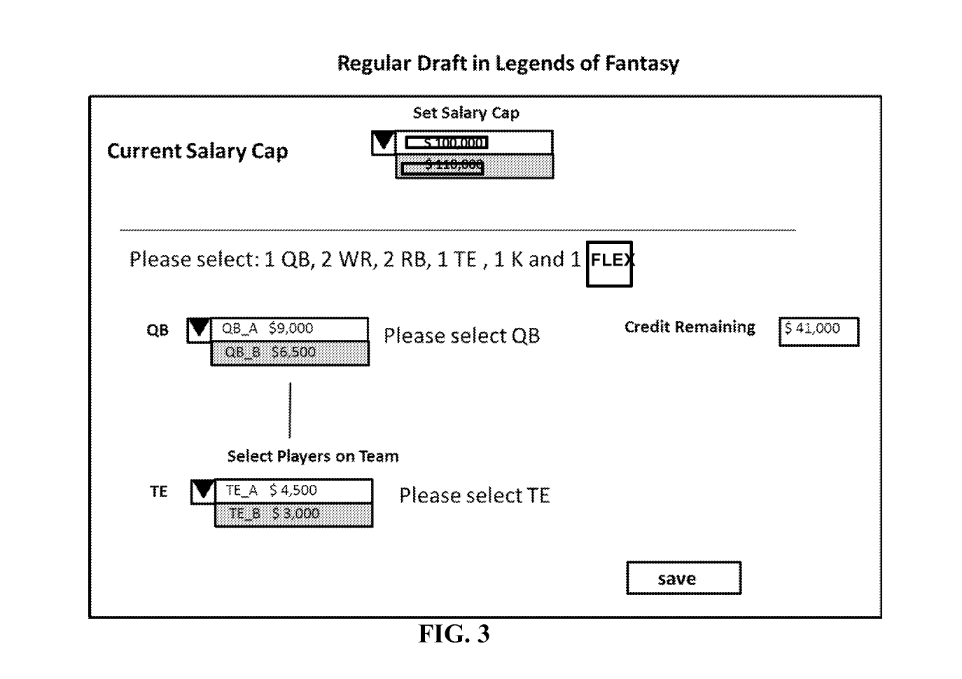

The system also stores for the sport which player with their uniquely calculated salary is made available for a selection which is called a draft herein. In the example screenshot of a draft provided in FIG. 3, the game is football and the salary cap is $100,000. A fantasy gamers is provided with an amount of draft credit to draft the players for a game within the salary cap. In one embodiment of the fantasy game every player has the same amount of draft credit. In another embodiment of the fantasy game a fantasy game player can buy additional credit, allowing that player to draft a team of higher priced players. The price (or salary) of a player in a real-life based game corresponds to the players relative performance valuation in real-life.

The money or credit spent on salary of players may be capped, for instance at $ 100,000, though other caps may be set by the game manager or administrator. For instance a salary cap may be set at $110,000, as illustrated in FIG. 3. The setting of a salary cap is a way by the administrator to allow a fantasy legend game player to draft a defined number of highly qualified and usually expensive players. For football, a “regular draft” which is the selection of players, a team has to be drafted from an available player list on the screen. The menu to select a player may be a drop-down many that lists the available players per position, such as Quarterback or Tight End. In one embodiment of the present invention a fantasy game player has to select one quarterback (QB), two wide receivers (WR), two running backs (RB), a tight end (TE), a kicker (K) and a team defense (TD).

A team must be selected within the salary cap of 50,000 or 100,000 or any other set salary cap. The system subtracts from the available balance each time a player is selected. The remaining credit amount is displayed on the screen. The system does not allow to select a player who does not fit within the salary cap. All required positions must be filled.

In one embodiment of the present invention there is no limitation on selectable players. In another embodiment of the present invention listed real-life players are only represented by one instance in a league. That is, when a real-life player is selected by a fantasy game player, the name of the real-life player will disappear from the list of selectable player for the other fantasy game players in a league. An order of draft selection may be provided by the system to the fantasy game players. In one embodiment of the present invention the first fantasy game player who selects the real-life player will add the real-life player to his or her team. In another embodiment of the present invention, each fantasy game player gets one turn for drafting for a specific position after which drafting for another position starts.

When the fantasy team is complete the team is saved with the owner id and draft id and the players selected.

When the fantasy games are played, points are awarded for yards gained and touchdowns for offensive players and for tackles, fumbles forced, points allowed and other statistics for team offensive and/or defense performance. The statistics for the points awarded correspond to a performance to a real-life player in a game, preferably a recent game, or even an ongoing game, or is derived from a performance of the real-life player in two or more games by applying a rating method, for instance by averaging the performance in a plurality of games.

The team within the draft with the highest scoring in points by combining scoring points from the individual drafted players is the winner of the prize pool for that draft or game related to that draft.

Legends of Fantasy Legend Draft

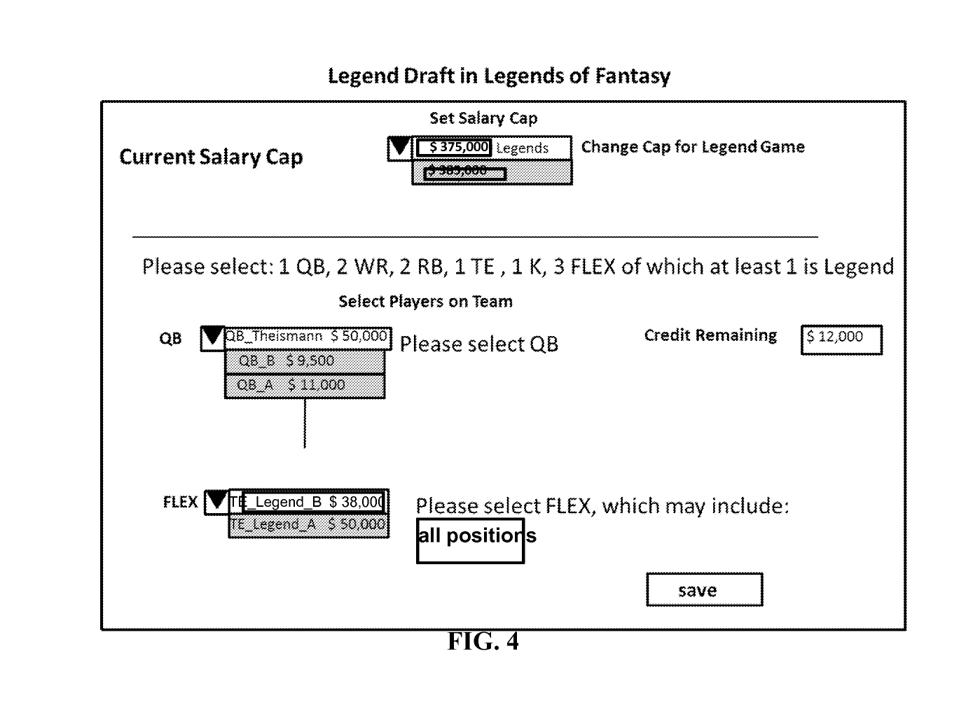

FIG. 4 illustrates a screenshot of a drafting page wherein at least one legend is drafted for a fantasy team position. The fantasy game player may have to indicate that playing in a Legend mode is desired by for instance changing the salary cap. This activates the Legend part of the menu. Depending on the selected mode one or more positions may be filled with legends. Clearly, with a salary cap being 100,000 and the salary of a Legend being 50,000, only one Legend position can be created. It is to be understood that other configurations are fully contemplated, including a salary cap of $150,000 that allows two Legends to be recruited.

In the illustrated screenshot in FIG. 4 only one Legend can be recruited if the salary cap would have been 100,000 and the cost of a legend player is 50,000. When the Legend mode is activated the fantasy game player can view all available players, real-life and living legend and retired legend in a drop-down menu. This is for illustrative purposes only. The number of real-life and legend quarterbacks in football, for instance, may be too large to be placed in a drop down menu. Another menu structure that may be applied is allowing a fantasy game user to type in the first letters of (in this case) a quarterback's name. The system then provides a list of suggested names that matches with the first provided letters. Other menu structures are also possible.

No matter what menu structure is applied, a fantasy game player can add at least one Legend player to the team. This results in the deduction of a salary that may be a salary of for instance 50,000 of the fantasy's player's salary credit. In this example the fantasy legend game player has a salary cap of 375,000, and has recruited several players, including a legend quarterback, in this example Joe Theismann for a cost of 50,000. The fantasy game player completed the team with 12,000 credits left. It is noted that while the $ sign is used for credits, no specific money currency is required. The credits may be assumed to be just a number of credit units.

The setting of a salary cap is a way by the administrator to allow a fantasy legend game player to draft a defined number of highly qualified and usually expensive players such as legend players. An administrator in one embodiment of the present invention changes (i.e. raises or lowers) collectively the salary cap of all fantasy legend players in a defined group or league. In another embodiment of the present invention a salary cap is changed based on a previous performance in a fantasy legend game by the fantasy legend game player. In yet another embodiment of the present invention, a fantasy legend player may buy a higher salary cap for a fantasy legend game, for instance from another player or from a game administrator. In yet another embodiment of the present invention a fantasy game player may lower a salary cap, for instance by selling part of the salary cap to for instance another fantasy legend game player or to a game administrator. A game administrator may be an automated administrator, such as a computer program on a server that executes preset game rules or a person.

Legends of Fantasy SWAP Draft

This SWAP screen appears after select SWAP draft is selected. The system provides a template for the selected type of draft and sport. Each draft type and sport has a team template which provides the number and type of positions that needs to be filled.

The system also stores for the selected sport and type of player with their uniquely calculated salary to make available for the draft. Stored players include real-life players and legend players. For a football SWAP, which is illustrated herein, a draft a team includes an available player list that is provided on the screen.

A player list may be a drop-down list that is activated by the fantasy game player. It may also be a list that is placed on the foreground by activating an icon, or a text or a URL. The selected player may be activated as a team member by clicking or activating the name or picture of the player.

In one embodiment of the present invention the player on the list is only available if the player has not been selected earlier for a team by another fantasy game player playing in a same league. In that case a specific real-life or legend player is no longer available for selection and the name of that player is greyed or made inactive for selection in the selection screen.

In one embodiment of the present invention a fantasy gamer must select one quarterback, two wide receivers, two running backs, a tight end, a kicker and a team defense.

In accordance with an aspect of the present invention, at least one player that is selected from the players list is a legend or a retired player in the sport of choice. For instance, in a football fantasy legend game, Joe Theismann, who is a retired football quarterback, may be selected as a legend player to occupy the QB position in the fantasy game. In a fantasy soccer game, for instance Johan Cruyff, a retired soccer player, may be selected as a center forward player legend.

In one mode of a fantasy game, a flex player may be selected from any suitable position. For example in fantasy football, the flex player in general is an additional running back, wide receiver, or tight end. In accordance with an aspect of the present invention, the flex player in a fantasy legend game may be selected from any position. In accordance with an aspect of the present invention a fantasy legend game has at least one legend player and at least one flex player. In accordance with an aspect of the present invention a flex player, is selected from a list of legend players. In accordance with an aspect of the present invention a flex player, is selected only from a list of legend players. In accordance with an aspect of the present invention a fantasy legend team has at least one flex player, one line backer (LB), one defensive lineman (DL) and a defensive back (DB). These are features which are believed not to be available in any other fantasy game at this time. Selection of at least one legend player in a fantasy game and selection of at least one legend flex player in a fantasy game is illustrated in the screen shot shown in FIG. 4.

In accordance with an aspect of the present invention for a selected legend player, either in a mandatory position or in a flex position, the system uses a random number generator to select or to determine a game performance of a legend player. In one embodiment of the present invention, the system uses a random number generator to select one specific game this player actually played and to provide the fantasy team with the points this legend earned using a priority scoring system.

A FOOTBALL SCORING CHART

| | |
|---|---|
| Stat | Points |

Quarterbacks ~ All Players

| | | |
|---|---|---|
| Passing Yards | .1 | point per yard |
| Passing Tds | 6 | points |
| 2pt Conversion | 2 | points |
| Rushing Yards | .1 | point per yard |
| Rushing TDs | 6 | points |
| Interception | −2 | points |
| Fumble Lost | −2 | points |

Running Backs/All Players

| | | |
|---|---|---|
| Rushing Yards | .1 | point per yard |
| Rushing Tds | 6 | points |
| Passing Tds | 6 | points |
| 2pt Conversion | 2 | points |
| Receiving Yards | .1 | point per yard |
| Interception | −2 | points |
| Fumble Lost | −2 | points |

Tight Ends/All Players

| | | |
|---|---|---|
| Rushing Yards | .1 | point per yard |
| Rushing Tds | 6 | points |
| Passing Tds | 6 | points |
| 2pt Conversion | 2 | points |
| Receiving Yards | .1 | point per yard |
| Interception | −2 | points |
| Fumble Lost | −2 | points |

Defense Player/All Players

| | | |
|---|---|---|
| Tackle | 1 | point |
| Blocked Kick/Punt | 2 | points |
| Safety | 2 | points |
| Forced Fumble | .5 | point |
| Fumble Recovery | 2 | points |
| Fumble Recovery Yards | .1 | point |
| Interception | 2 | points |
| Int Return Yards | .1 | point |
| Sack | 2 | points |
| ALL Defensive TD's | 6 | points |

FULL TEAM DEFENSE

| | | |
|---|---|---|
| 0 Points Allowed | 20 | points |
| 1-6 Points Allowed | 9 | points |
| 7-13 Points Allowed | 5 | points |
| 14-20 Points Allowed | 1 | point |
| 21-27 Points Allowed | −1 | point |
| 28-34 Points Allowed | −2 | points |
| 35-41 Points Allowed | −4 | points |
| 42+ Points Allowed | −7 | points |

Special Teams/All Players

| | | |
|---|---|---|
| Tackle | 1 | point |
| Forced Fumble | .5 | point |
| Fumble Recovery | 2 | points |
| Return Yards | .1 | point per yard |
| Fumble | −2 | points |
| Return TD | 7 | points |

Kickers

| | | |
|---|---|---|
| Extra Point | 1 | point |
| Missed Extra Point | −2 | point |
| Field Goal 17-39 yards | 3 | points |
| Miss Field Goal 17-39 yards | −3 | points |
| Field Goal 40-49 yards | 4 | points |
| Miss Field Goal 40-49 yards | −2 | point |
| Field Goal 50-59 yards | 5 | points |
| Field Goal 60+ yards | 7 | points |

A FANTASY HOCKEY SCORING SYSTEM
All HockeyPlayers

| Goals = | 1 | |
|---|---|---|
| Assists = | .5 | |
| Power Play Goals = | 1.5 | |
| Penalty Minutes = | −.1 | per minute |

| | |
|---|---|
| Shots on Goal = | .1 |
| Face-offs Won = | 1 |
| Game Winning Goals = | 2 |

Goaltenders

| | |
|---|---|
| Wins = | 2 |
| Loss = | −1 |
| Saves = | .1 |
| Goals Against = | −1 |
| Shutouts = | 3 |

A BASEBALL FANTASY SCORING SYSTEM
All Hitters

| | |
|---|---|
| Single = | 1 |
| Double = | 2 |
| Triple = | 3 |
| Home Run = | 4 |
| Run = | 1 |
| RBI = | 1 |
| Walk = | 1.5 |
| Stolen Base = | 2 |
| Caught Stealing = | −1.5 |

Pitching Staffs

| | |
|---|---|
| Win = | 3 |
| Loss = | −1 |
| Save = | 2 |

Strikeouts

| | | |
|---|---|---|
| Strike Out = | 1 | point |

Walks

| | |
|---|---|
| Walks = | −.5 |

Earned Runs Allowed

| | |
|---|---|
| 0 = | 7 |
| 1 = | 5.5 |
| 2 = | 3 |
| 3 = | 2 |
| 4 = | 1.5 |
| 5+ = | 0 |

Hits allowed

| | | |
|---|---|---|
| 0 = | 20 | points |
| 1 = | 15 | points |
| 2 = | 13 | points |
| 3-4 = | 9 | points |
| 5-7 = | 3 | points |
| 8-10 = | 1 | points |
| 11-12 = | 0 | points |

In another embodiment of the present invention, a random number generator is applied to bias a performance of the legend player in the fantasy game toward historical conditions of a selected game, as described herein earlier. In yet another embodiment of the present invention, a random number generator is applied to bias a performance of the legend player in the fantasy game based on a plurality of actual games played by the legend. Historical conditions of one or more actual games may be considered by the system.

In accordance with an aspect of the present invention a team must be selected and a salary cap must be maintained. In one embodiment of the present invention such a salary cap may be 100,000. The system subtracts from the available salary balance a salary of a player who is selected. The system does not allow to select a player who does not fit within the salary cap.

In accordance with an aspect of the present invention a legend has a fixed cost. For instance, that cost may be 50,000 in this type of draft, while the salary cap is 100,000. This makes it very difficult for a fantasy game player to load up the fantasy game with only the best players, as the fantasy game player will hit the salary cap and may not be able to complete the fantasy team.

In accordance with an aspect of the present invention, a fantasy game player can elect to increase for a cost the salary cap in order to create a large cap fantasy team. Such an increase will be added to the salary cap allowing the fantasy game player to afford one very high priced or more higher priced players on the team.

In accordance with an aspect of the present invention, only one legend player may be selected on a fantasy game team. In accordance with another aspect of the present invention, no more than two legend players may be selected on a fantasy game team. In accordance with another aspect of the present invention, more than two legend players may be selected on a fantasy game team. In accordance with another aspect of the present invention all players on a fantasy game may be legend players. In accordance with another aspect of the present invention, all players or all selected players on a fantasy game are legend players.

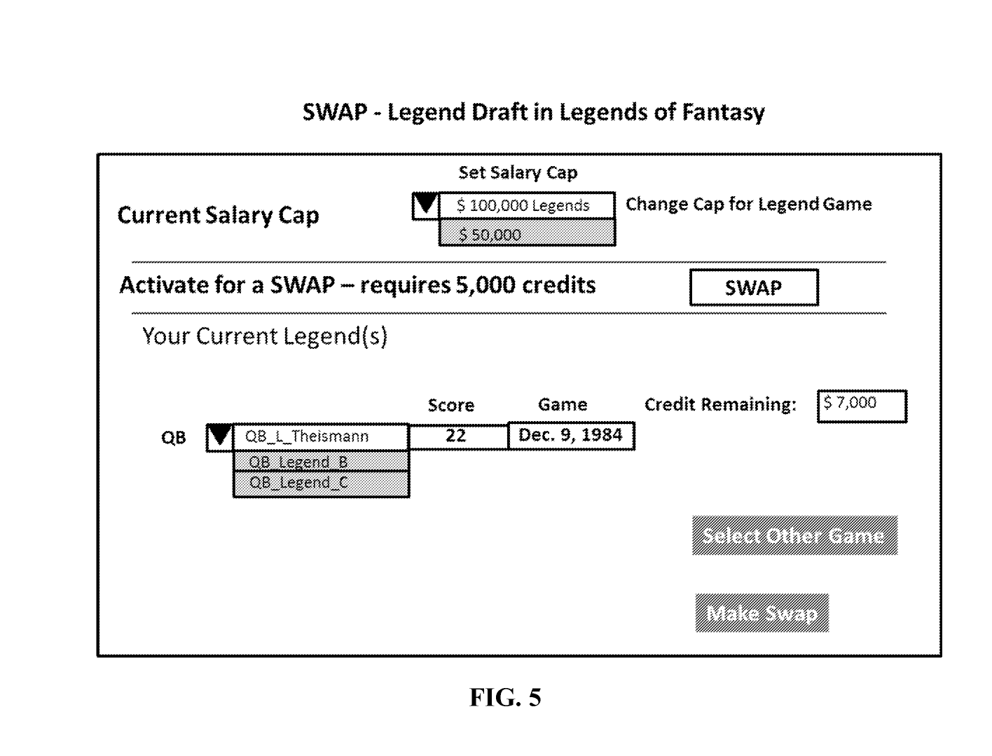

In accordance with an aspect of the present invention, a swap may be performed. For a cost, the system will display the legend game and/or the legend points that contribute to the score of the fantasy team. It will allow the fantasy player to select another game for this legend or to generate a different random number based score. In accordance with another aspect of the present invention a fantasy game player may also swap the selected legend player for another legend player. The SWAP functionality is illustrated in FIG. 5, wherein a swap costs 5000 credits.

In a single swap selection this feature can only be used once. In a swap or a multi-swap the generated game of the selected legend player or the selected legend player can be swapped multiple times.

In accordance with an aspect of the present invention a player of a fantasy legend games is offered a global swap, that allows the fantasy legend game player to swap two or more players for other players or other games or in yet another embodiment of the present invention would allow to swap all team members or their scoring games to be swapped. In one embodiment of the present invention a fantasy legend game player is offered to select a “global swap” option, for instance by paying for that option. This allows the fantasy legend game player to review the games and scores of all legend players in a draft. If the fantasy legend game player is not happy with a score of one or two or of more than two legend players, the fantasy legend game players can swap the legend players or may request to select a new legend player scoring game. It is noted that the generation of a legend scoring game depends on a random number generator and there is no certainty that a next selected scoring game would yield a better score of the legend player.

When the games are played, points are awarded in fantasy football for instance for yards gained and touchdowns for offensive players and for tackles, fumbles forced, points allowed and a few other statistics for team defense. Each fantasy sport has its own performance rating a point scoring rules. The team within the draft or league draft with the highest number of points is the winner of the prize pool for that draft or league.

A league is a group of fantasy game players that play against each other. A league, may be an ad hoc league, formed to play a single round of drafts and games and may be dissolved after the drafts and related scoring have been entered and evaluated by the system. A league may also exist and continue for a plurality of games or drafts or for a complete season or for as long as fantasy game players want to participate in a league.

A league on the system wherein a fantasy game player participates may be dissolved and a new league may be formed wherein the fantasy game player participates.

As mentioned above, FIG. 5 illustrates a screenshot intended for the SWAP process in accordance with an aspect of the present invention. By paying an amount, in this illustrative example 5000 credits, a fantasy game player is offered the opportunity to review the score of the legend and on which game this is based. After enabling the SWAP mode, the system provides a menu structure and the information related to a game from which the scoring was determined. One can see that a game played on Dec. 9, 1984 by Joe Theismann was used to determine 22 points is a scoring system. If the fantasy game player is happy with that score, the score can be accepted. In accordance with an aspect of the present invention, a different quarterback can be selected by clicking on a dropdown list or by a selection of a quarterback in any other valid menu structure.

It may also be that the fantasy game player is happy with the earlier selected legend quarterback, but not with the game selected by the system. By activating the “select other game” button, the system, for instance based on the random number generator, will select a different game for scoring purposes. The previously selected game cannot be selected in the SWAP.

In accordance with one aspect of the present invention a SWAP can be performed only once. In accordance with another aspect of the present invention a plurality of SWAPs can be performed. In accordance with a further aspect of the present invention all SWAPs have to be performed in a single session. A session may be the period between a sign-on and completion of the draft. A session may also be the session relating to visiting the SWAP page. One may perform multiple SWAPs while still on the SWAP page. However, once the SWAP page has been left, no further SWAP is possible. In one embodiment of the present invention a deadline is set for completing a draft. One may store intermediate draft steps on a server and sign-off from the server and continue working on a draft at a later stage but prior to the deadline.

In one embodiment of the present invention a fantasy game player may perform a SWAP anytime and possibly with payment of credits, before the deadline. In another embodiment of the present invention, a SWAP may be performed prior to announcing a winner, wherein the fantasy game player is allowed under a SWAP to review the team's score, but not the individual team player scores. In one embodiment of the present invention, a SWAP may be performed prior to announcing a winner, wherein the fantasy game player is allowed under a SWAP to review the team's score, and the legend player's selected game and score.

In one embodiment of the present invention, a SWAP may be performed after announcing a preliminary winning score. Any fantasy game player in a league who wants to do so may perform a SWAP within a defined period, after which the scores of the participating fantasy players become final.

In accordance with various aspects of the present invention there are different conditions under which a SWAP can be initiated

Fantasy of Legends—all Legends Draft

In this mode only legend players can be selected. The rules for the legends only draft are similar to any other draft—a complete team needs to be built. In accordance with one embodiment of the present invention a unique template is provided which includes three flex positions and includes, for the first time it is believed, a defensive lineman (DL); a linebacker (LB); and a defensive back (DB). Also legend flex players may be included in an all legends draft.

The system for a mode that is legend enabled is adapted to allow a unique salary for each legend. This allows the legends draft to have the salary cap feature of a regular draft within the legends format.

As the legends are selected by the fantasy game player the system may select one game, in a manner that may be driven by a random number generator, that this legend actual played and assign the performance points from that game to the total points for that team. Another feature of the legends draft is that the drafts can be held in that sport's off—season as the legends games have already been played.

Exporting Files

In accordance with an aspect of the present invention, after a user or a fantasy game player has selected a team from any type of draft, the user can export the player list or the team for this draft to another computer. The server creates an export file of the team including, the players' name, position, salary and other relevant data. In one embodiment of the present invention the export file is in a csv format. This allows the user to import and save the team he has just drafted to his or her own computer so they can track in their own way how each team did. A fantasy game player may also store team data and related data on a server system that hosts the game. A fantasy game player may have an application or some home tracking system, which is applied to improve gaming results in the future.

In accordance with a further aspect of the present invention a line-up or selected team is stored on a server as a final or intermediate result. When stored as an intermediate result, the fantasy game player can stop working on creating a team and store the temporary draft for later further development or completion. A fantasy game player can develop or store multiple drafts in a game. However, only one final draft is allowed to be submitted per single registered fantasy game player name. Submitting multiple teams is allowed for a single fantasy game player by registering multiple sign-on names.

Storing and retrieving and importing a selected players' line-up allow a user to reuse a line-up that they have developed or even used in a prior draft. A line-up can be saved by a fantasy game player by draft id and/or user id or by a specific draft ID, so if a fantasy game player has success with a line-up they may want to use it again. The import allows a fantasy game player to import the players as previously selected into a new draft game without having to completely rebuild the team.

The system is provided with an editor that allows a fantasy game player to edit the imported line-up. For instance a fantasy game player may use a legend line-up with at least one legend player into a game that allows no legends. In that case the salary cap of the imported line-up is not in compliance with the requirements of the current game. The server disables saving or activating the imported line-up in the current game. Only after the fantasy game player has removed the legend player or replaced the legend player with a real-life player and has lowered the salary cap to the required level in the imported line-up, will the server accept the modified line-up which has to be saved under a new name.

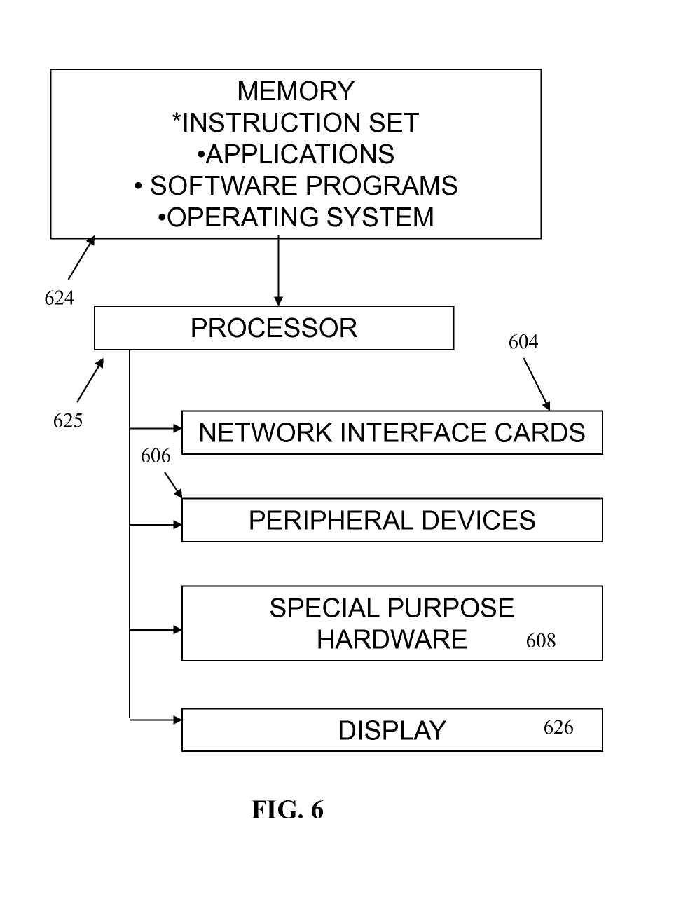

FIG. 6 illustrates a computing device that is part of a fantasy legend game system as provided herein. The servers and the computing stations include storage and memory devices 624 to store data and instructions that can be retrieved from 624 by a processor 625, an optional display 626, input devices and other peripheral devices and input/output ports 606, and network connection devices such as network interface cards 604. Special purpose hardware 608 may also be included. Each of the processes and steps described herein are implemented using the processor 625 and the storage 624 and any required ancillary device that form the responsible part of the computing systems of the present invention. Any number and any arrangement of computing systems can be used to implement the present system. Any of the methods and steps described herein can be implemented using the computing system including the computing device of FIG. 6. Additionally, any of the methods and steps described herein can be implemented on any of the processors in any of the servers illustrated in FIG. 6, or on any remote processor found on the Internet.

The following describes in detail an embodiment of a fantasy legend game in accordance with various aspects of the present invention as an illustrative example.

A website hosted on a server may host every day drafts at entry fees from a low price such $0.50 a team per draft to a high price as much as $1,000,000 a team per draft for the six major sports. A hosting fee may be collected for each and every draft. These daily drafts for all sports may range from 2 to 10,000 team entries with most of those drafts being multi team entry drafts, meaning the user can have more than one team in any overall draft. In every multi team entry available draft there may be a limit as to how many teams any one user can have. For example in a draft with one thousand teams and prizes given to the top one hundred overall users for instance a fifty team max may be set for multiple entries, and for a one hundred team entry draft a twenty team limit may be set to entice more users to draft more teams.

With smaller drafts such as ten team entry drafts, two teams may be the max number of teams any one user is allowed, and all of the users are encouraged to use multiple teams in all multi entry contests.

A Salary Cap Draft option is provided as a draft of choice. In a Salary Cap Draft the user will choose their team and then choose to add or swap in a Legend to it. Meaning one may swap a Legend like the late Derrick Thomas for a current player or as a FLEX. The user can also add any Legend from any position, including QB to play as their FLEX. The same is true with all sports except in other sports the FLEX position is called a UTIL, this may be a SWAP IN for regular formatted drafts. Also a SWAP IN feature is offered with the ADD a Legend Option in other games as well. Salary Cap Drafts that run in conjunction with the live season of any sport may have a cap of $100,000 to fill a team. With all of the Legends price tags set at $50,000 and with the current players price tags ranging from as low as $2,000 to as high as $20,000. The Legends salaries may only vary in a Big Draw contests and in year long leagues that are hosted on a system in accordance with an aspect of the present invention such as, the Legends of the Diamond, Ice, Hardwood, and of course the NFL.

The price tags for current players may flux as to what opponent they are playing for every given week through live feeds provided by data providers such as SportsData for instance.

Additions to Fantasy

The Random Game Generator

The Random Game Generator or “RGG” is what the software provided in accordance with an aspect of the present invention is called to randomly select a game for the Legends past to use in our current contests of skill and Fantasy Slots. Set at Game One for All Legends of all sports the RGG then selects a random game and will continue to do so.

The Legends

The Legends may in one embodiment of the present invention contain the top 40-120 players of all time in every position in every sport. Some legends will be Living Legends, and some will only be Fantasy Legends. Legends may include Manning, Brady, Peterson, Adam Vinatari, but also have Alshon Jeffrey and Doug Martin being that they are both Fantasy Beasts. All of the games used will be chosen at random for the Legends on a roster by the RGG, and all game data provided is from a sports data provider. The Fantasy Scoring Scale is a custom scale which is provided in accordance with various aspects of the present invention.

Inside Options

In accordance with an aspect of the present invention an Insider Options is offered. The user can select to add on credit, for instance as little as $1,000 to as much as $100,000 depending on the draft they select to their salary budget of $100,000 to $400,000 in any of our drafts for just $0.50-$5.00. Also the user can find out the Legend or Legends Fantasy points for illustrative amounts of $0.50-$5.00 depending on what contest of skill the user is. Here the games will selected through the RGG as well. For example, the lower $0.50 example option will allow a one time look-see for the Legend or Legends, the $1 option is a three time look-see either per Legend or the Legends depending which draft the user is in. The $5 option is unlimited for the selected Legend or Legends that are eligible to be seen. The same is true in contests with all Legends as well.

The Legend Bowl

In accordance with an aspect of the present invention, a Legend Bowl is provided, that will have multiple versions for multiple sports, Legendary College Bowls in particular, will have one consisting only of the players that are currently playing in the Super Bowl as is with regular fantasy drafts but in this embodiment a game player has the ability to add in a Legend of choosing. This gives players like Marino or the late Steve McNair the opportunity to in a way, play in, and possibly win the Super Bowl in a sense.

The Legendary Crossover or True Fantasy

In accordance with an aspect of the present invention, the user/player selects one of the following players from each of the corresponding sports. One Quarter Back, Pitcher, Point Guard, Center (NHL), Running Back, Infielder, Shooting Guard, Wing (NHL), Wide Receiver, Outfielder, Forward or Center (NBA), Defensemen or Goalie (NHL), PLUS Any Position Player that the USER Chooses but is limited to ONE Legend per sport from the NFL, NBA, MLB, and NHL so 16 legends in total.

The Legend's Showdown

This draft in a fantasy legend game is an all out Legend vs Legend game using all draft combinations once available for all sports but consisting of players that are Legends only. A timer may be implemented that starts when the draft room fills and then launches one hour after. Users in these drafts will be notified via their profile that is hosted on the server.

Legendary College Bowls

In accordance with an aspect of the present invention sub categories such as Legends of the Rose for the Rose Bowl are hosted. The same breakdown for The Legend Bowl would apply here and work for all Bowls in College Football, where a Legendary College Player that either played in that particular bowl in which the user is drafting for or is a Legend who never had the opportunity to play in any Bowl can be drafted.

Creating a Legend

As a challenge series to get the users to earn an opportunity of a lifetime by winning their way into “The Legend Bowl” or the Legendary College Bowls that coincides with the Super Bowl or running Bowl Games. The series includes a 10 draft minimum per user where the buy in can be as low as $0.50 or as much as $7.00 per draft. The Creating a Legend Challenge series includes the NFL Sunday Night Games, Monday Night Mash Up & Thursday Night Thirty. For example, the first 40,000 winning users of these challenge series may earn their way to The Legend Bowl. One other insider for this is just by playing the higher entry fee contests within the Creating a Legend challenges as opposed to the lesser entry fee draft challenges the user could get an additional 20 overall points that could help earn their way into The Legend Bowl.

The Season Of Legends

The Season of Legends is like The Legend's Showdown and will be able to be played all year long. This is a statistical season draft where users can choose the Legends for all slots on their team. These games may last 24 hours or less and have small draft rooms between 2-100 entrants. Users can choose an entire team such as the 1986 Bears starting line up of, QB, RB, WR, WR, TE, FLEX, D, K to face some of the players from the 1974 Steelers team in a Legendary Team Draft as well, but in this draft one can not move any players. The players stats may be randomly chosen by the RGG. OR the user could have players from the 1986 Mets squad versus some of the players from the 2013 Boston Red Sox, the possibilities are endless. Within this contest each Legend on each team would not play the same week as one another unless the program randomly selected it, but because our RGG counts Legends picks as an overall total for the site, not per draft, the Legends games are truly random. So even if Terry Bradshaw was in the same line up as Lynn Swan they would not be playing the same week, thus taking away the possibility of a user rigging the system.

The Series of Legend

In accordance with an aspect of the present invention The Series of Legend is provided and hosted on a server as a Baseball Big Draw and has a potential to either be the 2^{nd} or 3^{rd} biggest draft of the hosted site overall. It has the same concept as The Legend Cup and The Legendary Finals, only it's America's past times version. Here users will enter either a game by game draft coinciding with the current World Series or an overall Draft known as The Series Of Legend. The individual World Series game day drafts may be held as a secondary drafts that may include multiple mini drafts at every price point. The winner of The Series Of Legend may be determined by overall fantasy points earned during the entire current World Series. The entry fee into The Series Of Legend may vary and may for instance be $100 at 50,000 entrants with the top tier prize for The Series Of Legend being $2 million and a secondary prize pool of $1.5 million divided amongst the top 10,000 users within the draft. Smaller versions may also be provided.

The Legendary Finals

The Legendary Finals is The Legends of the Hardwood's Biggest Draw and like Baseball it runs along the same lines as The Cup of Legend. The everyday drafts for Basketball once available will be called “Weekly” starting with the day of through the following Saturday Day games. Dailies are for the day games. Like the Cup of Legend and the Legend Bowl, here the user can pick a Legend to swap in or add on to their true Fantasy Basketball Roster. Users will have the option to do the game to game drafts or here also or play in the Legendary Finals where we host an overall championship for all games played in the NBA Finals. In the Legendary Finals the user with the highest overall score for all games within the current NBA Finals wins. For this Big Draw Contest of skill there will be a 250,000 user entry maximum at $50 an entry with 100 multi teams max allowed. Like the other Big Draws here 50,000 users will also get a chance to win their way into the Legendary Finals as well. The top prize for the Legendary Finals will be $1.5 million with $1.5 divided amongst the top 10,000.

The Cup of Legend

The Cup of Legend is hockey's Big Draw where before each and every game in the real Stanley Cup Finals there will be drafts for either each individual game or the Finals as a whole. The everyday drafts are called Face-Offs, with the corresponding day linked to it. Like The Legend Bowl, here the user can pick a Legend to swap in or add on to their true Fantasy Roster. Users will have the option to do the game to game drafts or also play in The Cup of Legend where we host an overall championship for all games played in the Stanley Cup Finals. In the Cup of Legend the user with the highest overall score for all games within the Stanley Cup wins. The Cup of Legend is a $2 million dollar Stanley Cup showdown, where the winner collects $1 million dollars and the other million is divided amongst the top 10,000 players. This, like The Legend Bowl, may have 250,000 entrants at for instance a $50 entry fee, multiple entries allowed. Also like the Legend Bowl 50,000 users can earn their way to The Cup of Legend.

Legends of the Green and Legendary Duo's

Legends of the Green and Legendary Duo's are two versions of a fantasy legend game in accordance with various aspects of the present invention. In version one, Legendary Duo's, users choose a Legend and a current player playing in a tournament and can challenge other users to do the same in a head to head match up. Version two may contain either an Auction or Snake style draft with for instance 2-10 players max per draft and wherein where the for instance 25 top rated current golfers are in the Que along with the top 25 all time winning-est golfers in history and everyone either bids or picks depending on the draft style. The system in one embodiment of the present invention provides Day 1, 2, 3, 4, and overall tournament final draft games, meaning one normal tournament can lead to five different day drafts overall along with the option of running thirty types of drafts per day. Within the Legendary Duo's drafts there may be four spots to fill, and in auction drafts the user may have for instance $100 to spend on the players with some players costing $50 and on down to $2, for example.

Salary Cap Drafts allows the user for instance $50,000 to fill the four spots with some players costing $25,000 and on down to $2,000. Snake Drafts are always straight pick drafts.

Million Dollar Minute

In accordance with an aspect of the present invention, Million Dollar Minute is available for all sports that are provided herein and is a Million Man Draft. These contests are within the Season of Legends Contests only and start as the room fills. A maximum number of multi-entries per user for these contests may be 1,000. It is called Million Dollar Minute because you never know exactly when it will go off. So anyone, anywhere, can become a millionaire in a minute.

Partner Up

Partner Up, which is provided herein in accordance with an aspect of the present invention, is an embodiment of a contest that has never been done before in the world of Fantasy Sports or in the world of business, it is where users are provided with an opportunity to be partners with the authority hosting the fantasy legend game. Partner Up is a overall contest of skill that is hosted where for instance 100 drafts are set at for instance $10.00 an entry fee with each being a contest of for instance 100 teams per draft room and for instance 20 multi teams max per user, keeping in mind that in this example all 100 drafts will only compete for 0.01 guaranteed point of the company each. Then the 100 winners will face off for 1 full point overall in a draft that costs them nothing to get into except to have won in the previous draft. As always both of the Insider Options cost $1.00. Here also a “buy in option” may be provided for other users to enter the draft that have not previously won before. The system may be maxing that number out at for instance 10,000 additional entrants/users with 10 team max entry so the previous winners who earned their way do not have a bad taste in their mouths. The “buy in” price may be $100.

Legends of the Raceway

In accordance with various aspects of the present invention a NASCAR Fantasy Draw is provided, where the user can draft three driver's in either a Salary Cap or Auction and Snake drafts. The user may select two current drivers and one Legend. The Legend's Pool for this may contain the Top 20 to 50 driver's of all time. In the Salary Cap version the Legendary Drivers may cost $50,000 as the Budget for 3 drivers may be $75,000, and the current drivers may range from $5,000 to $25,000. The insider option that may be added in for our NFL, Legend's drafts is also available here as well as in all sports. The user can spend $1.00 to up their budget $10,00 and/or pay to find out the Legends Fantasy Point total. In the Snake Draft it is as simple as all Snake Drafts, straight pick. In an Auction Draft the budget may be $200 with all of the drivers ranging from as high as $100 to as low as $25.

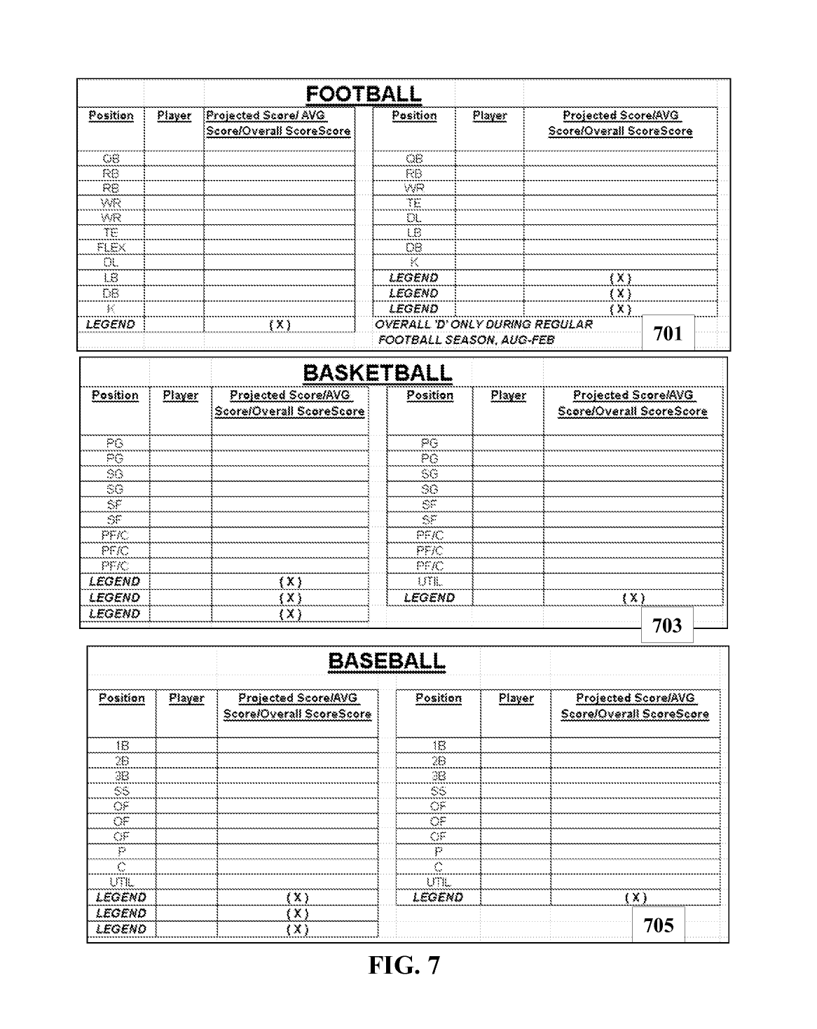

FIG. 7 in 701, 703 and 705 illustrates a roster for a fantasy legend game for football, basketball and baseball in accordance with at least one aspect of the present invention, respectively. FIG. 8 in 801, 803 and 805 705 illustrates a roster for a fantasy legend game for hockey, soccer and racing in accordance with at least one aspect of the present invention, respectively. FIG. 9 in 901 illustrates a roster for a fantasy legend game for golf in accordance with at least one aspect of the present invention.

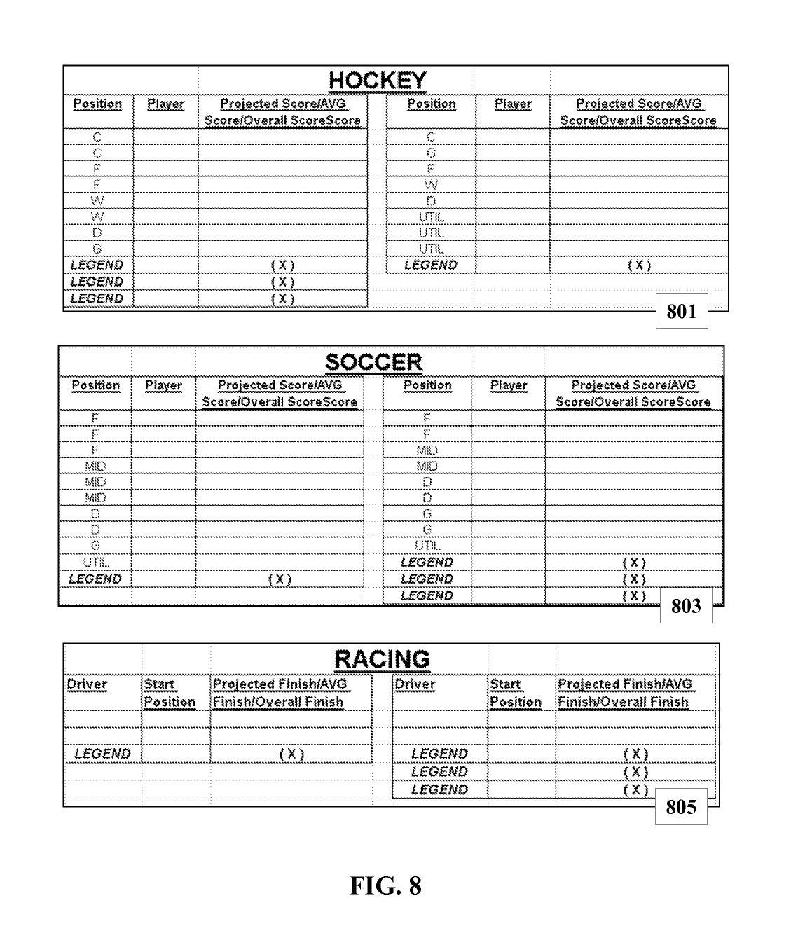

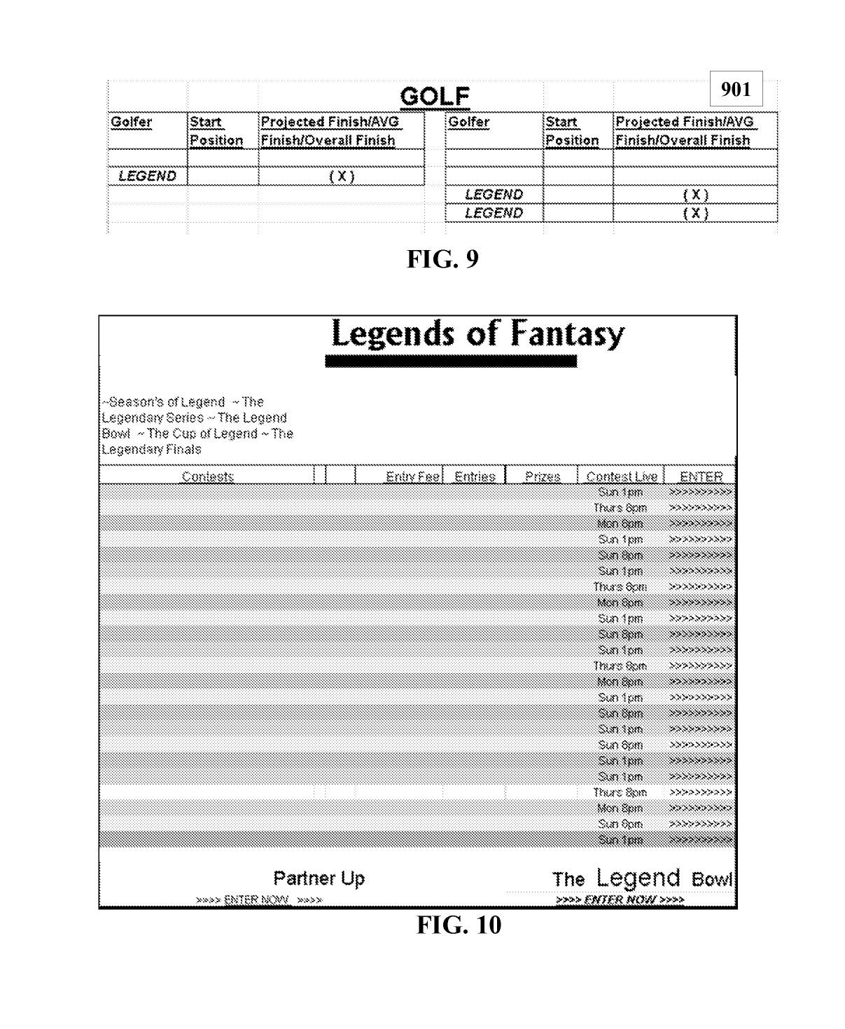

FIG. 10 illustrates a user interface for selecting a fantasy legend game in accordance with an aspect of the present invention.

In one embodiment of the present invention a fantasy legend game is hosted on a server and results are shared with a game player on a networked or client computer, for instance through a user interface. In one embodiment of the present invention a fantasy legend game is installed and played on a single computer.

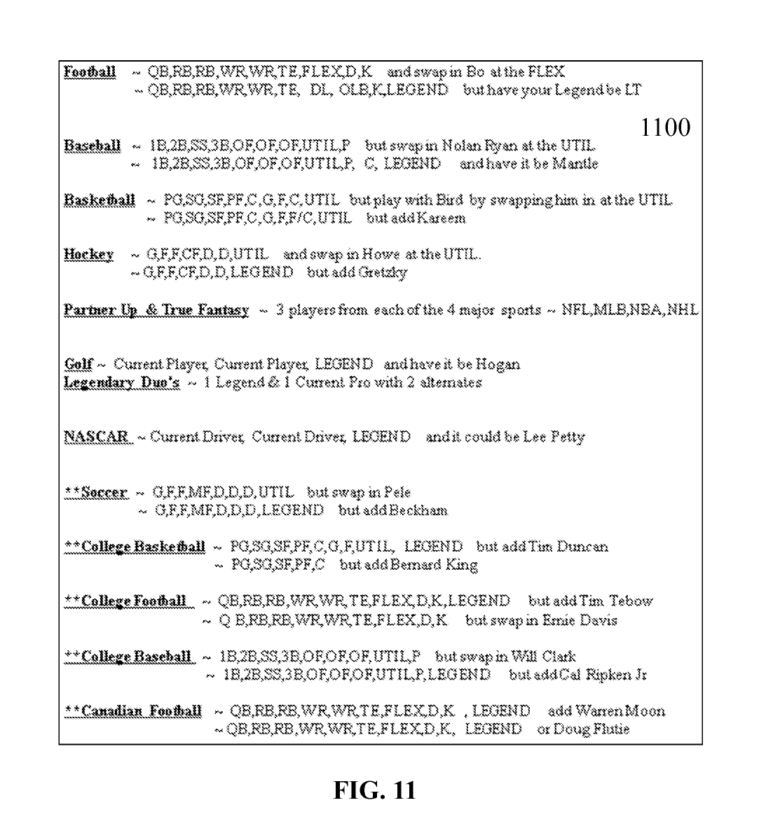

As provided earlier, a fantasy legend gamer is enabled to swap either a score of a legend player or an entire legend player in a draft in accordance with various aspects of the present invention. Panel 1100 in FIG. 11 provides an illustrative example of swaps for different sports to illustrate this concept of a swap.

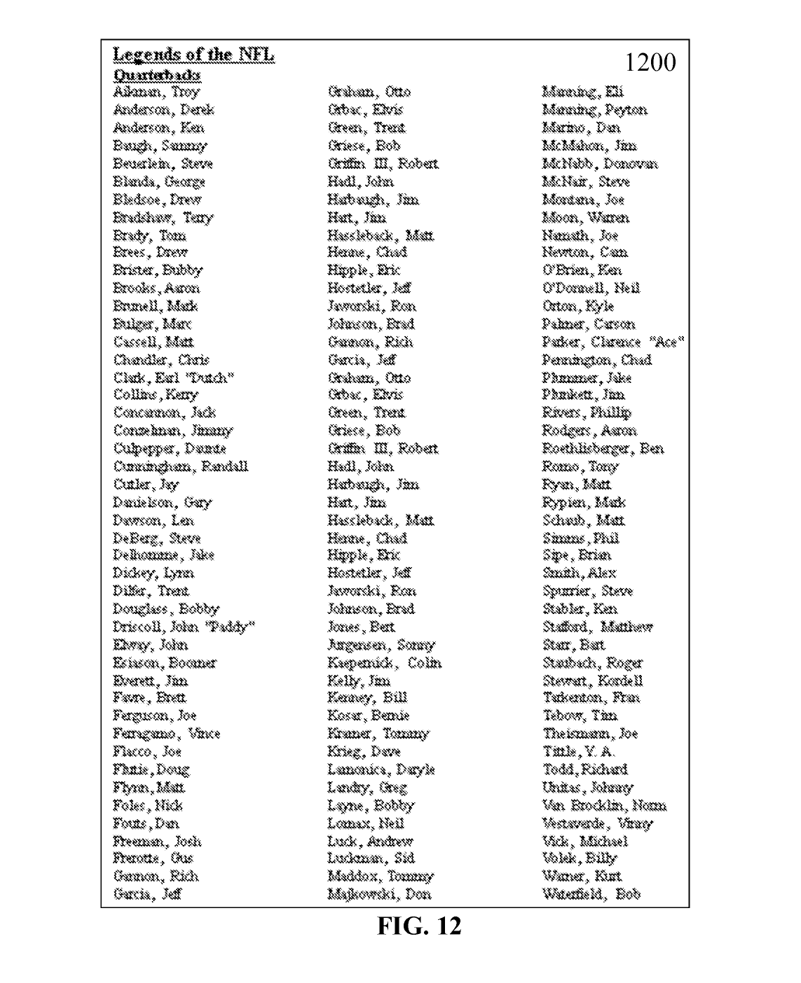

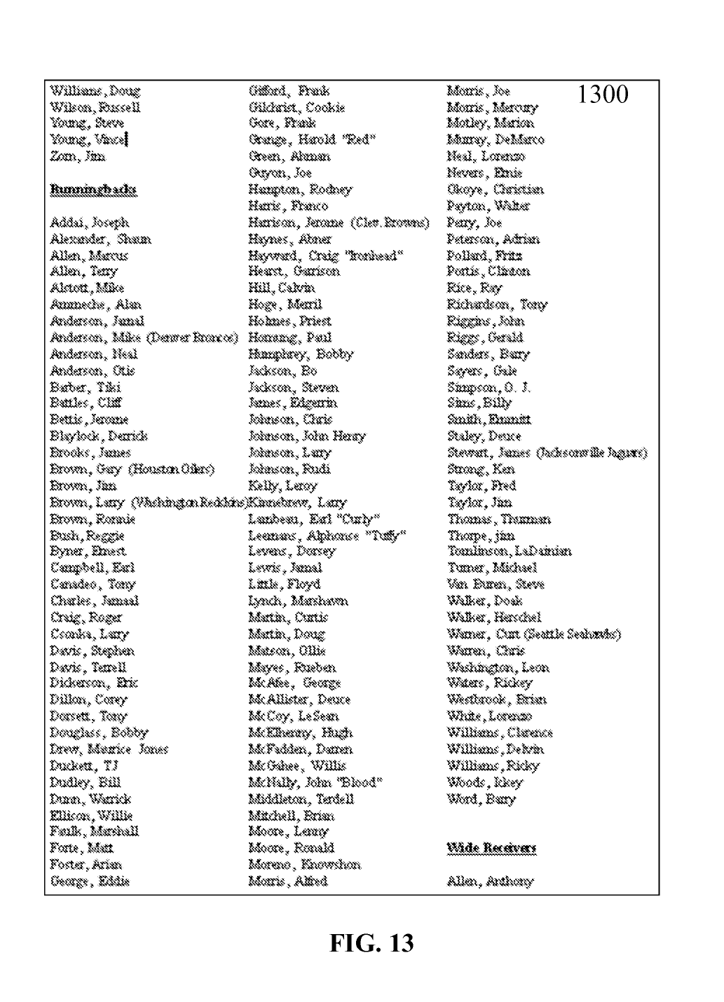

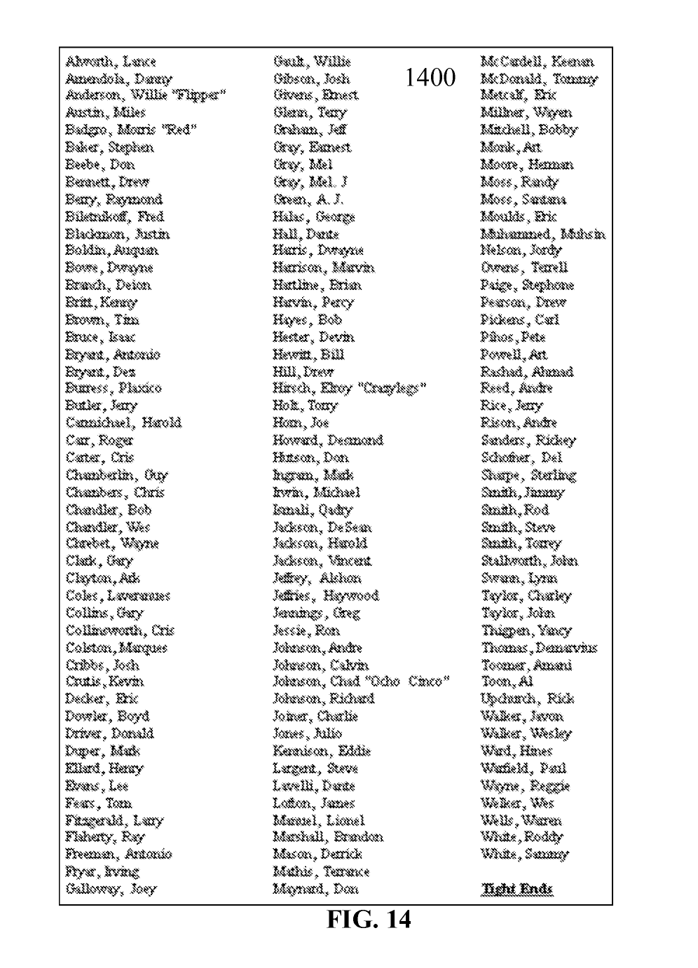

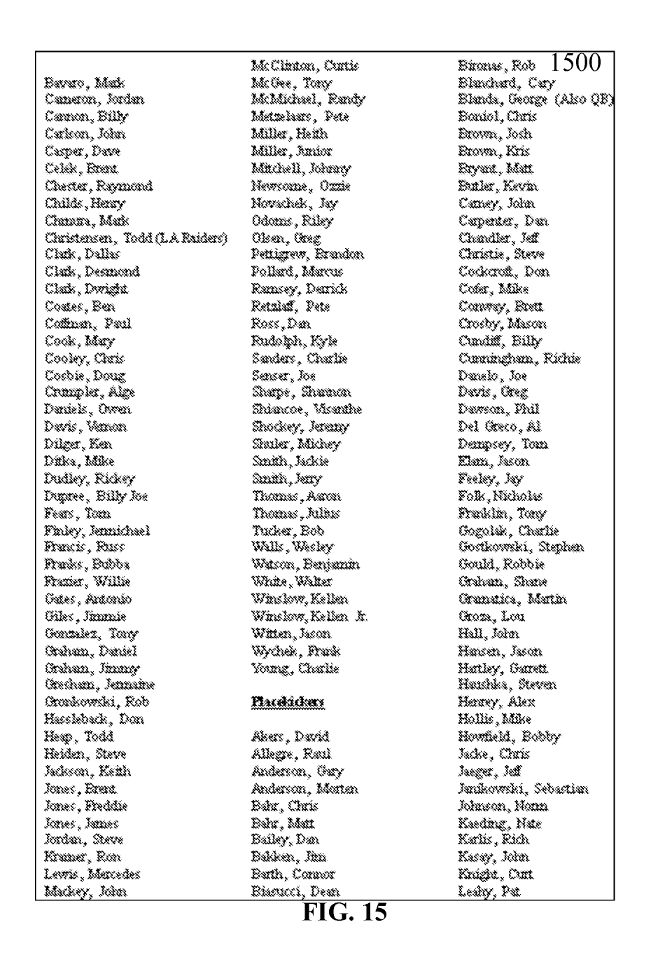

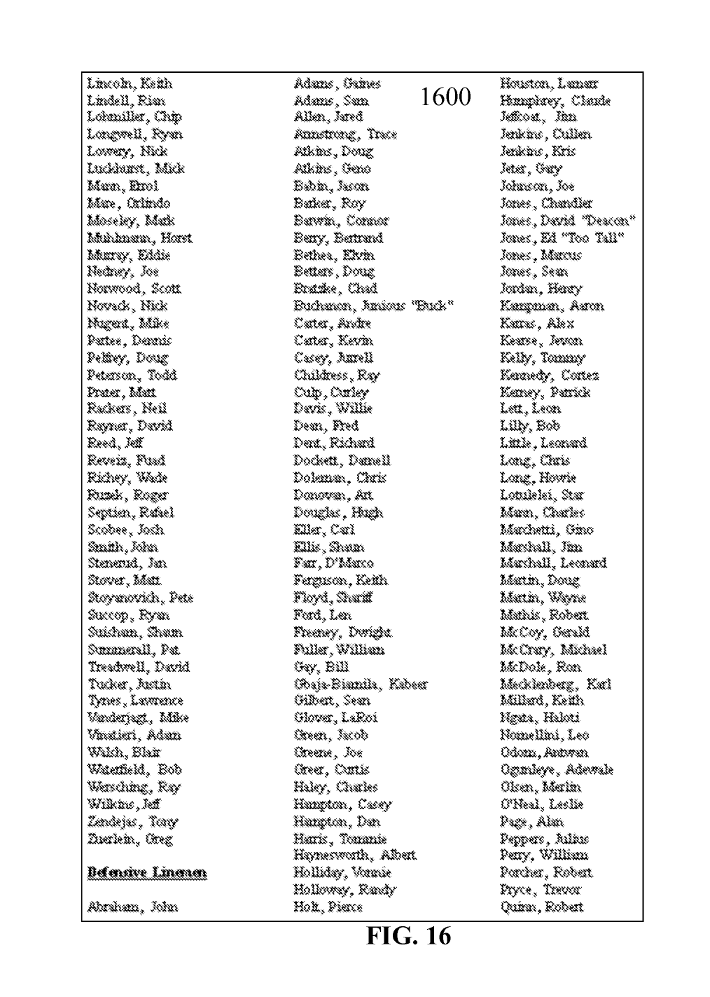

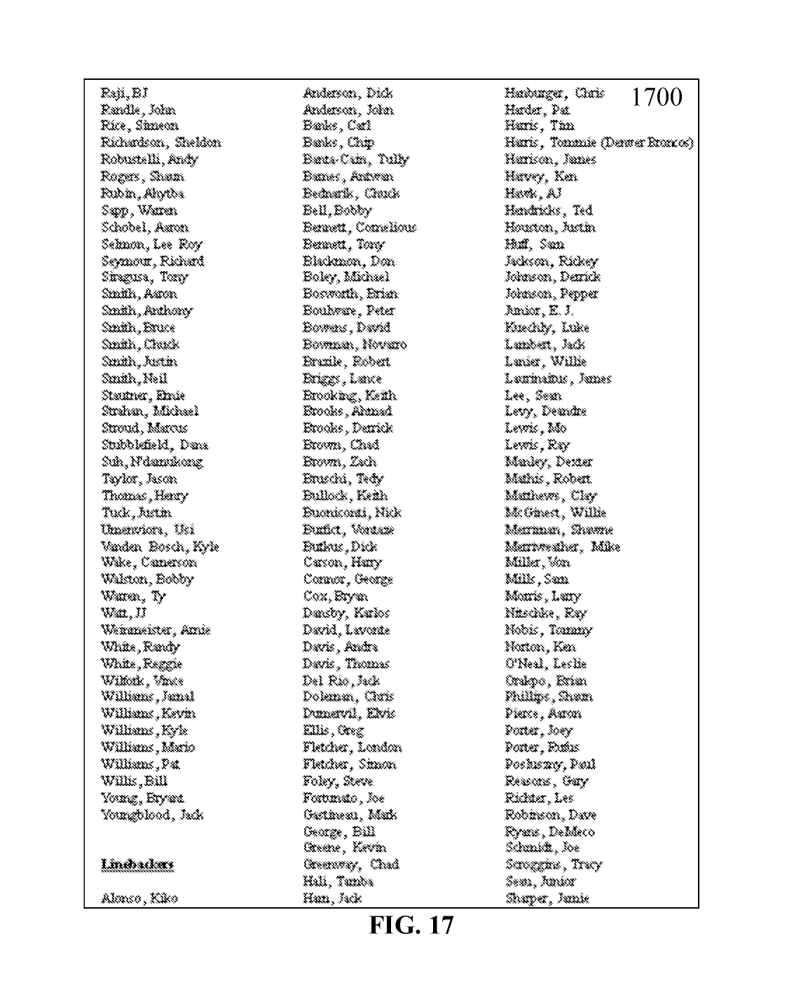

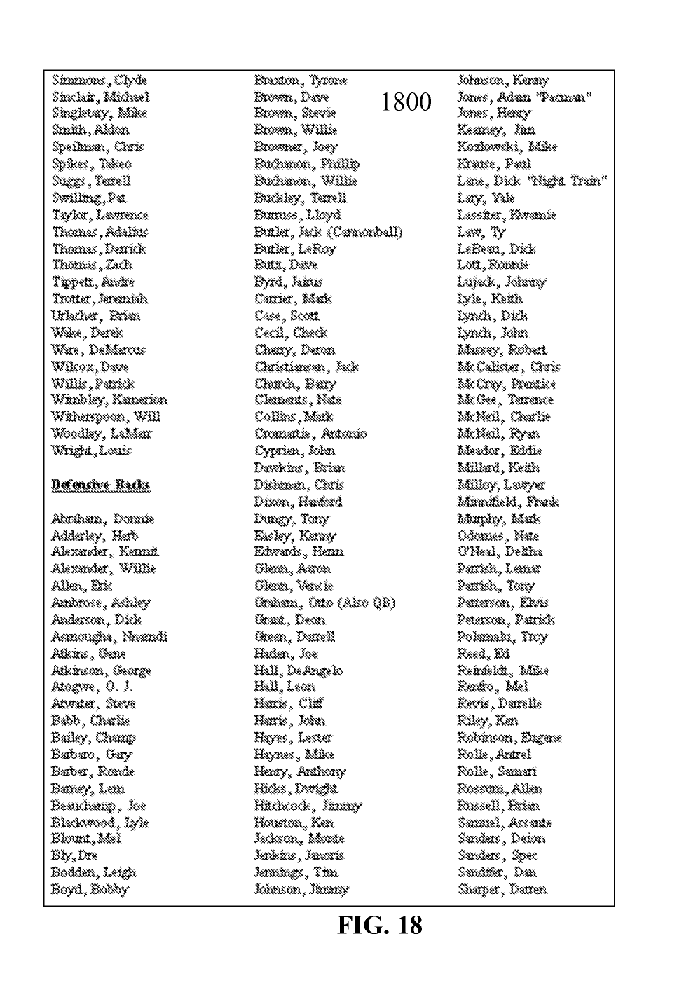

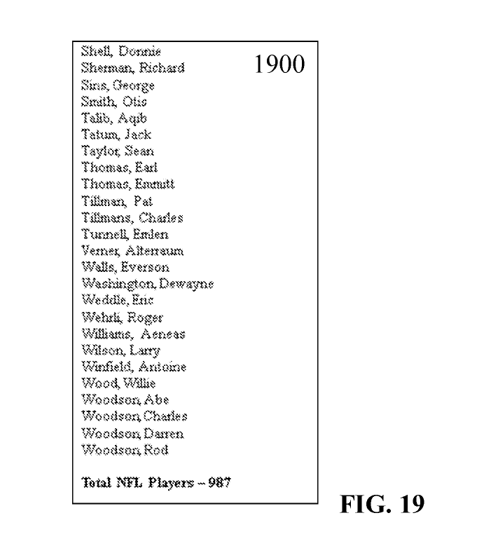

One aspect of the quality of a fantasy legend game is the of course determined by the quality of the legends. Another aspect of a quality is that sufficient legend names are available to select from. In accordance with an aspect of the present invention a fantasy legend football game is provided with at least 900 legend players from which a selection can be made. In accordance with an aspect of the present invention a fantasy legend football game is provided with at least 100 legend quarterbacks to select from. One or more panels with legend football players, which may be presented to a fantasy legend game player on a computer are shown in FIGS. 12-19 in individual panels 1200, 1300, 1400, 1500, 1600, 1700, 1800 and 1900.

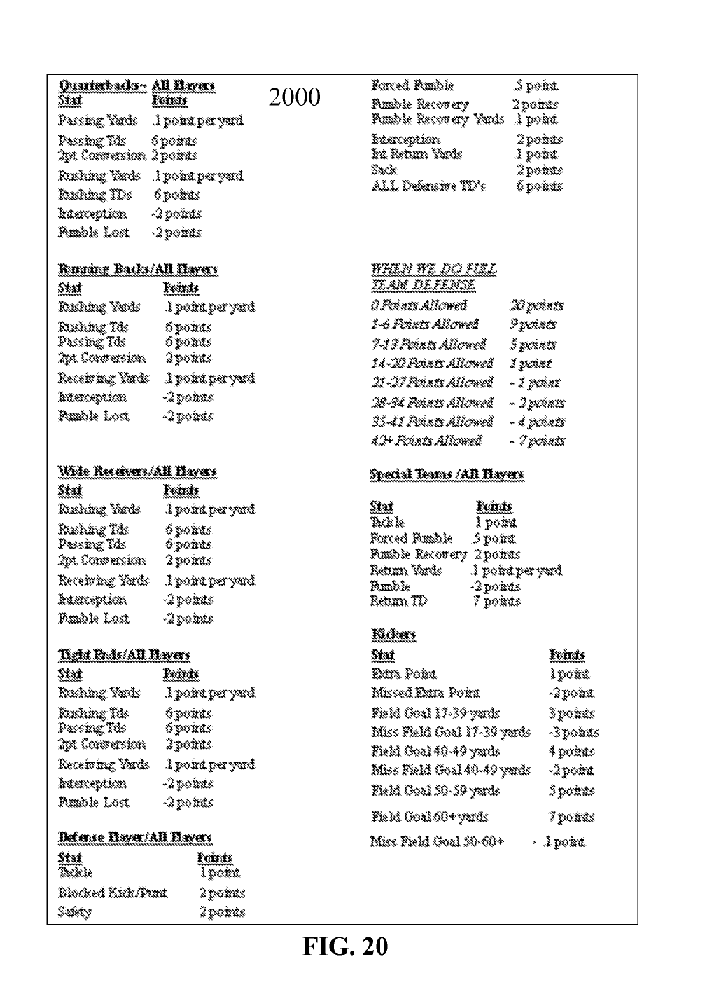

In accordance with an aspect of the present invention a scoring of a player in a playing position in a game is provided and calculated. FIG. 20 in panel 2000 illustrates a scoring for different positions in a football game. Such a panel may be presented to a player of a fantasy legend football game on a computer.

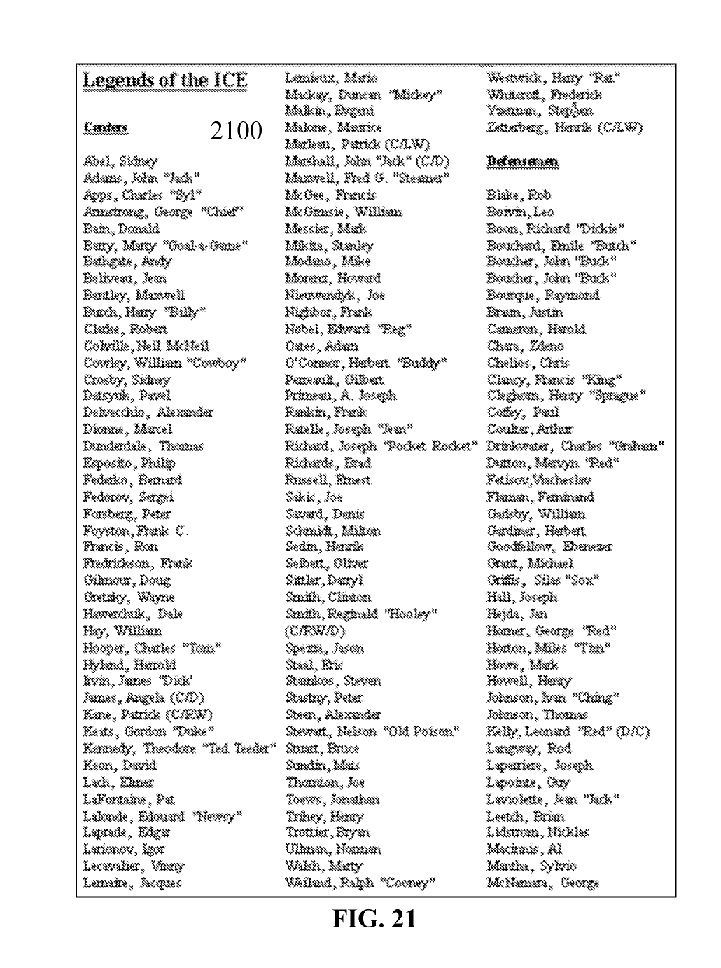

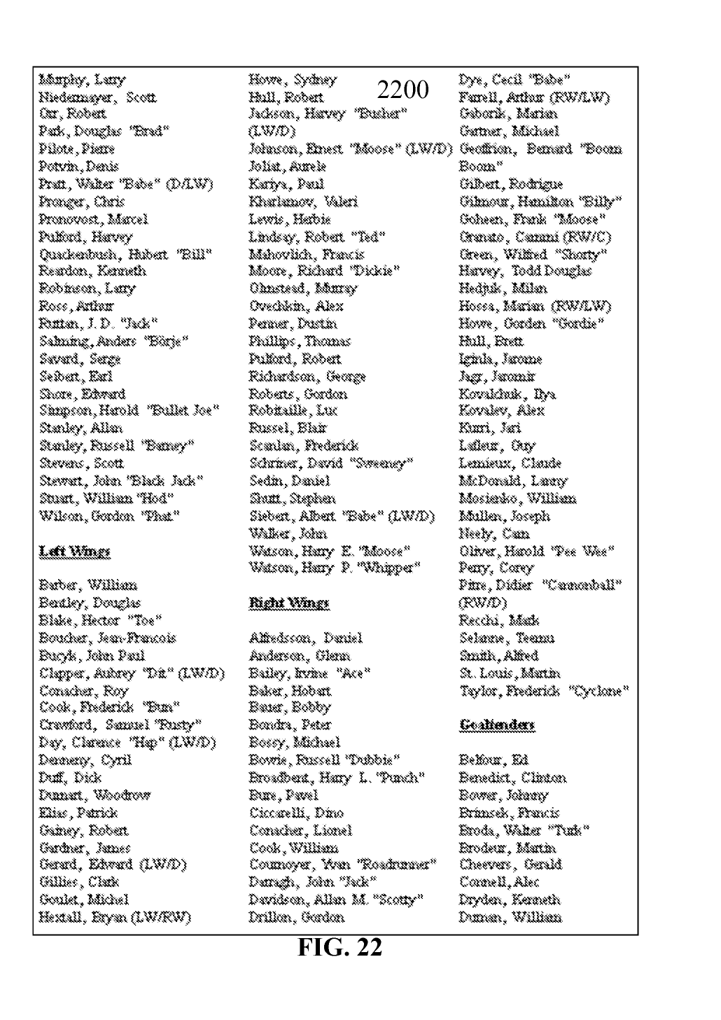

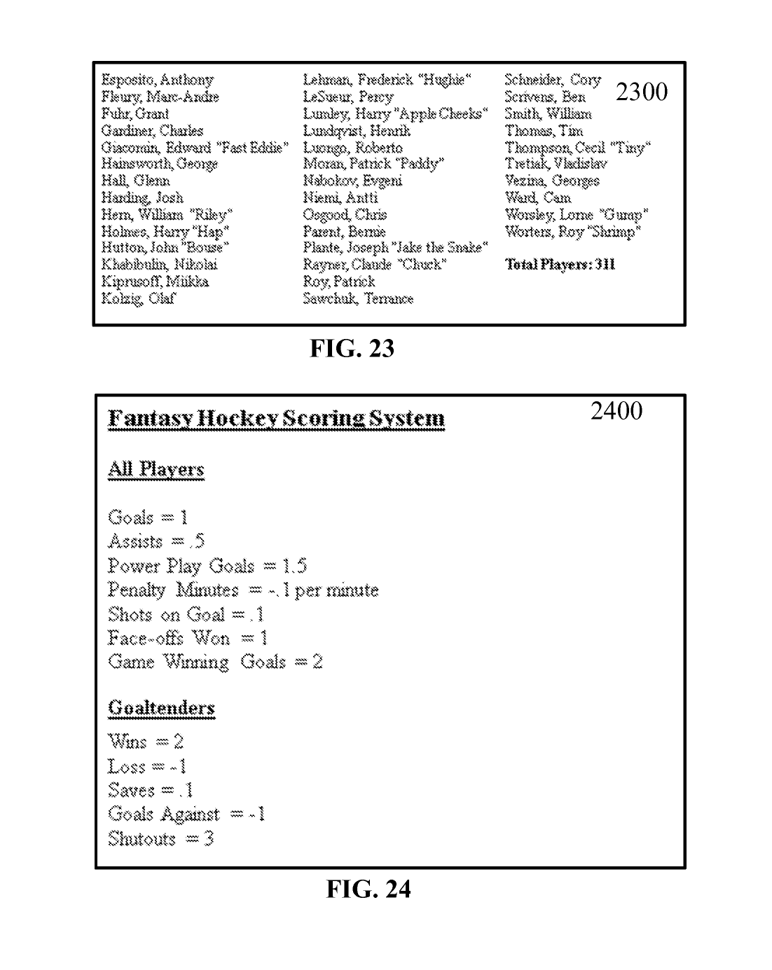

In accordance with an aspect of the present invention a fantasy legend hockey game is provided with at least 300 legend hockey players to select from. One or more panels with legend hockey players, which may be presented to a fantasy legend game player on a computer are shown in FIGS. 21-23 in individual panels 2100, 2200 and 2300.

In accordance with an aspect of the present invention a scoring of a player in a playing position in a hockey game is provided and calculated. FIG. 24 in panel 2400 illustrates a scoring for different positions in a hockey game. Such a panel may be presented to a player of a fantasy legend hockey game in accordance with an aspect of the present invention.

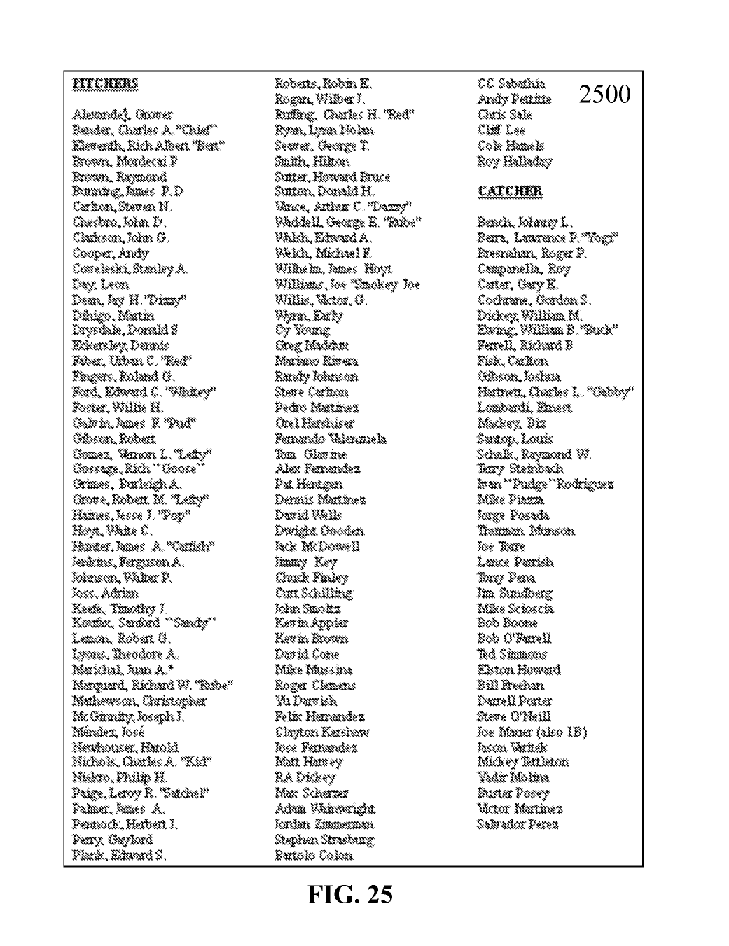

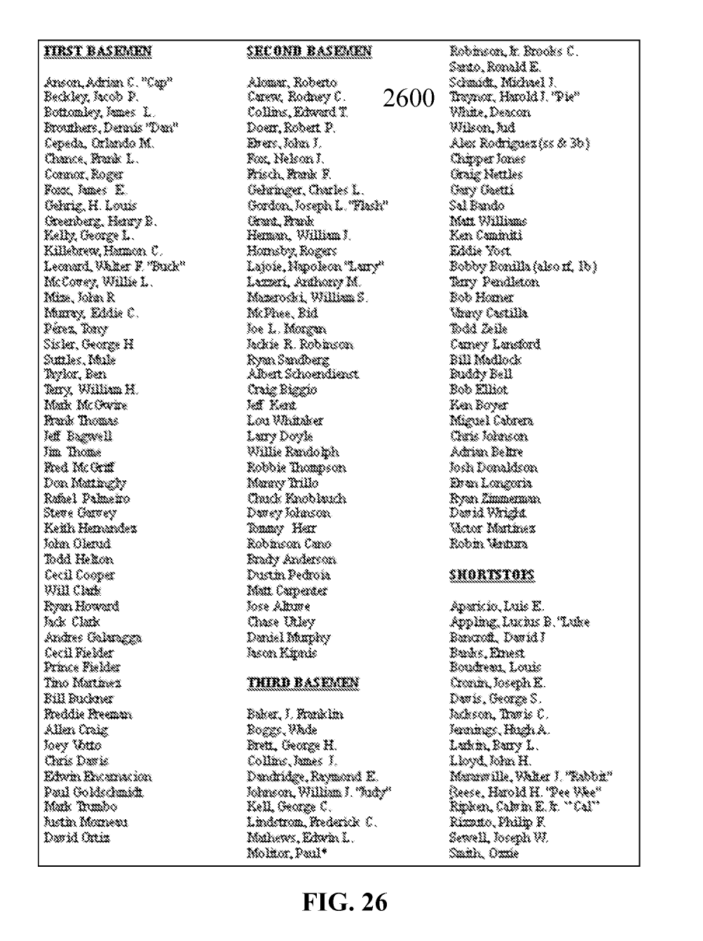

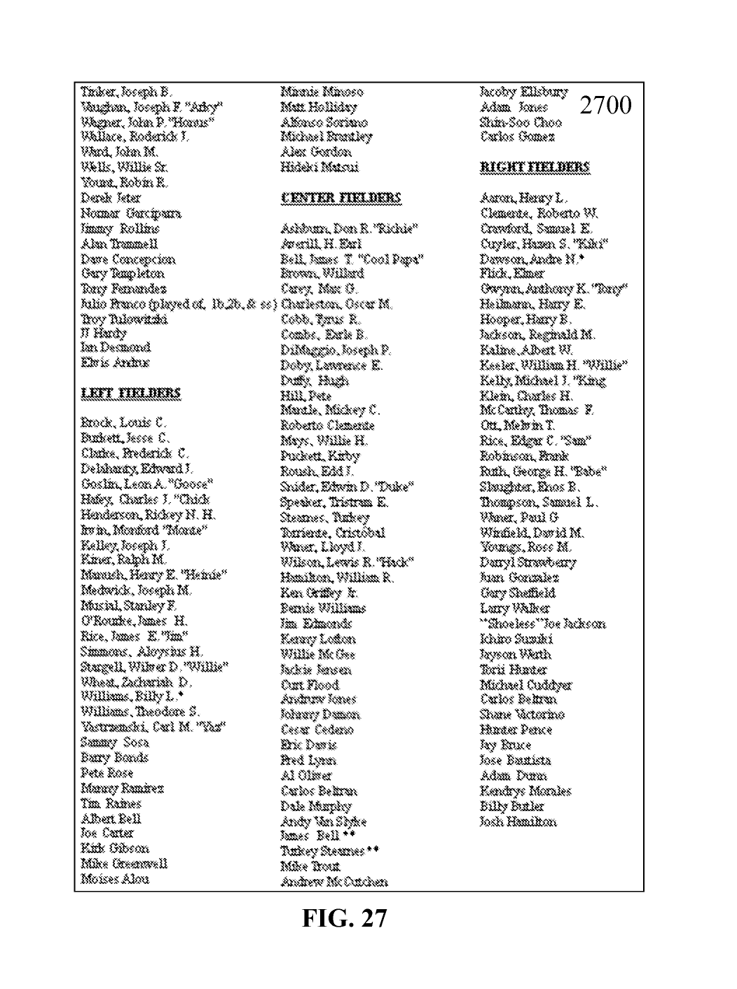

In accordance with an aspect of the present invention a fantasy legend baseball game is provided with at least 200 legend baseball players to select from. One or more panels with legend baseball players, which may be presented to a fantasy legend game player on a computer are shown in FIGS. 25-27 in individual panels 2500, 2600 and 2700.

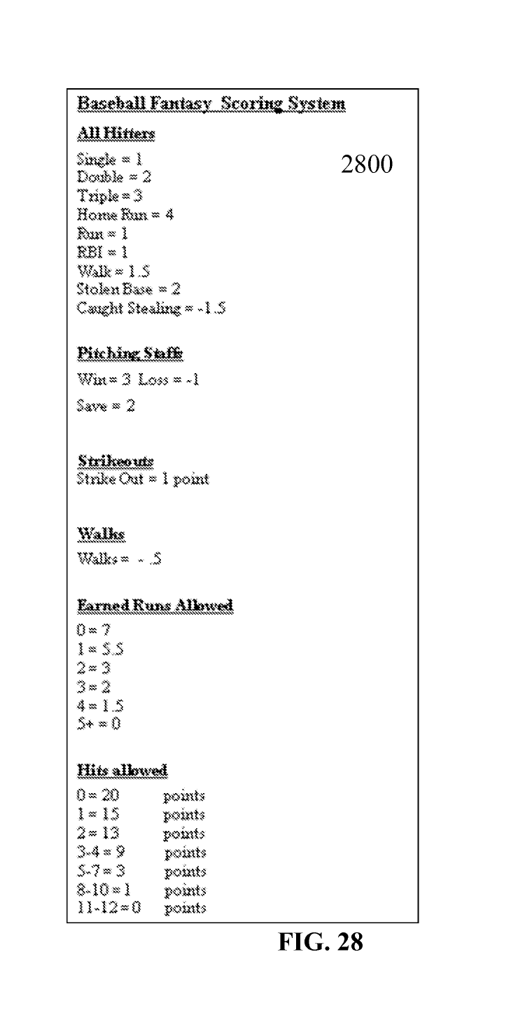

In accordance with an aspect of the present invention a scoring of a player in a playing position in a baseball game is provided and calculated. FIG. 28 in panel 2800 illustrates a scoring for different positions in a baseball game. Such a panel may be presented to a player of a fantasy legend baseball game in accordance with an aspect of the present invention.

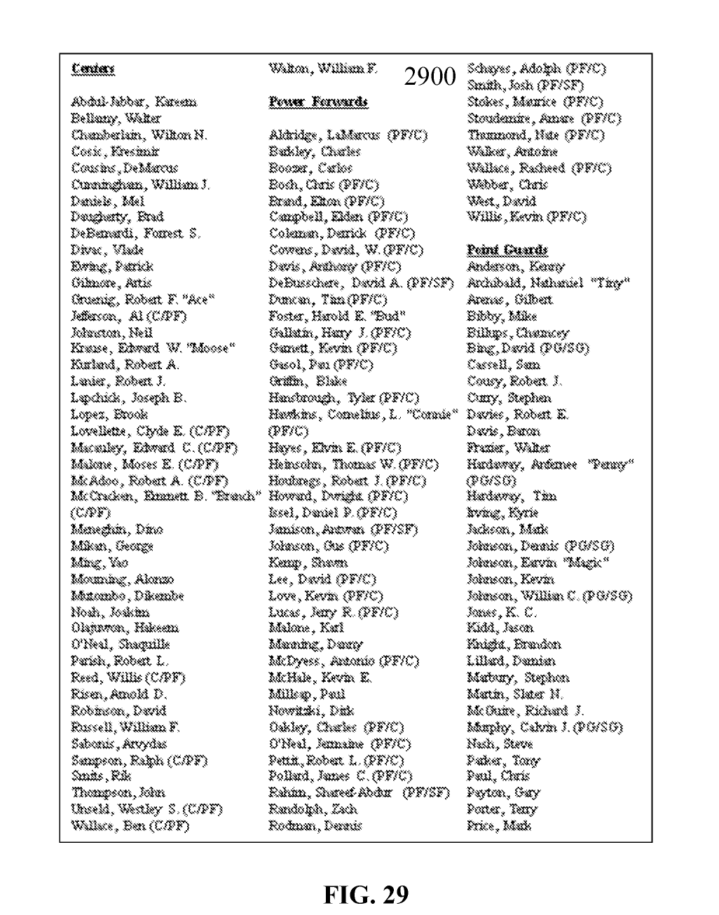

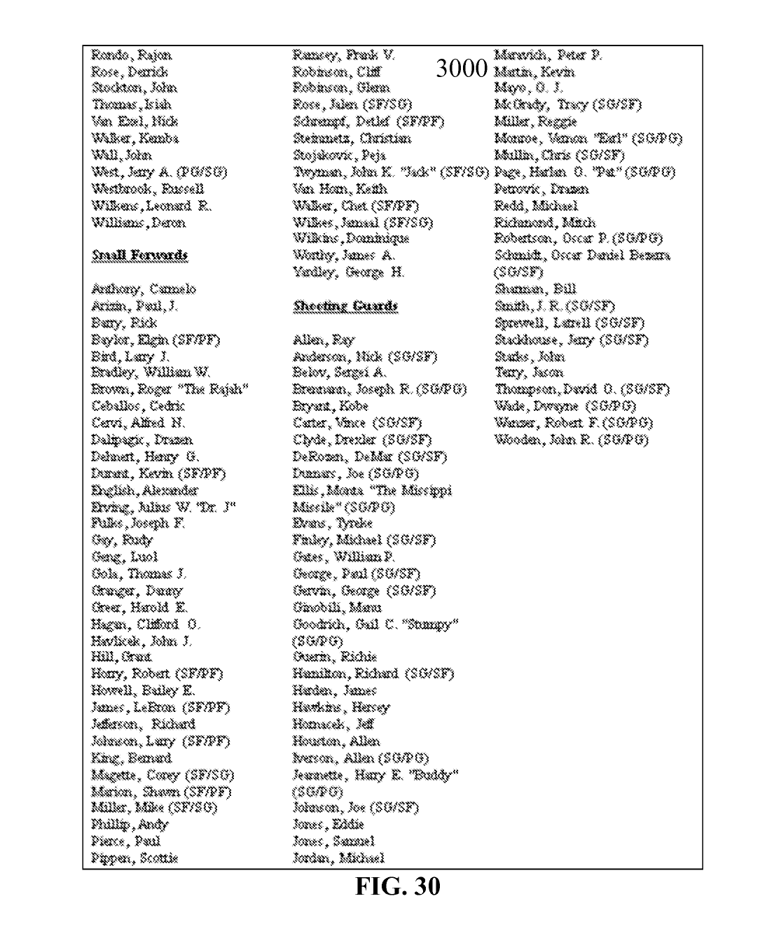

In accordance with an aspect of the present invention a fantasy legend basketball game is provided with at least 140 legend basketball players to select from. One or more panels with legend basketball players, which may be presented to a fantasy legend game player on a computer are shown in FIGS. 29-30 in individual panels 2900 and 3000.

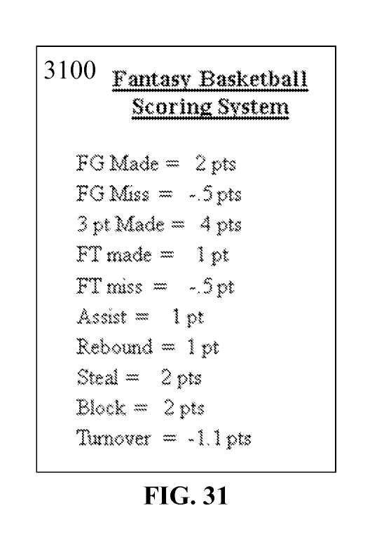

In accordance with an aspect of the present invention a scoring of a player in a playing position in a basketball game is provided and calculated. FIG. 31 in panel 3100 illustrates a scoring for different positions in a basketball game. Such a panel may be presented to a player of a fantasy legend basketball game in accordance with an aspect of the present invention.

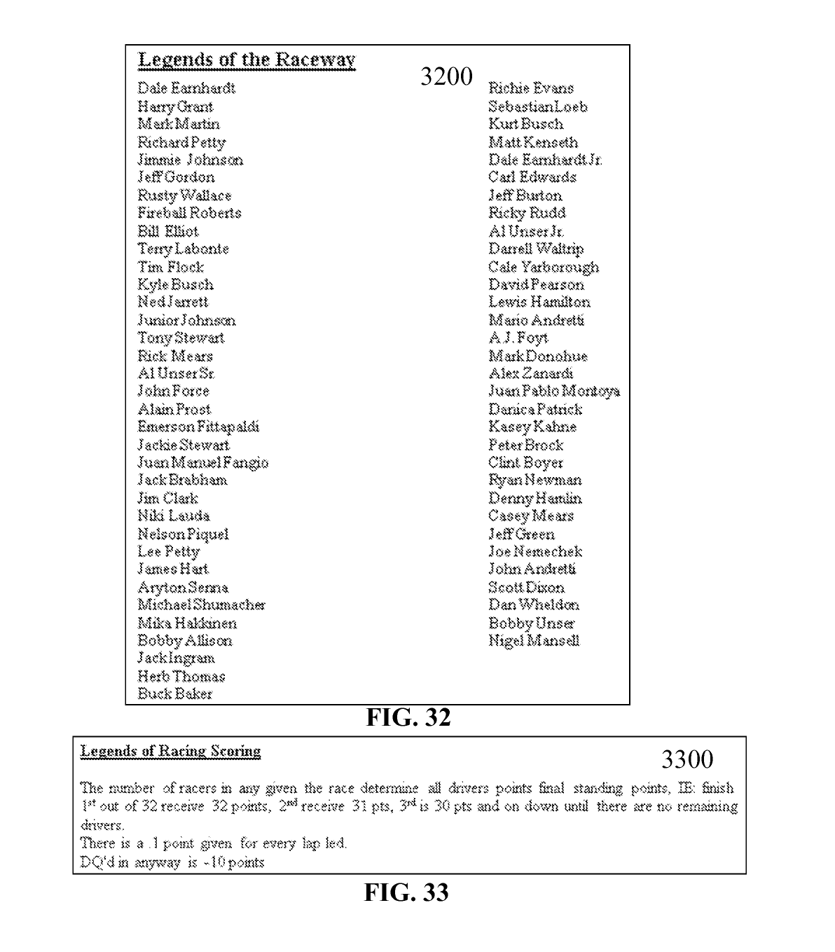

In accordance with an aspect of the present invention a fantasy legend car racing game is provided with at least 50 legend drivers to select from. A panel with legend drivers, which may be presented to a fantasy legend game player on a computer is shown in FIG. 32 in individual panel 3200.

In accordance with an aspect of the present invention a scoring of a driver in a car race is provided and calculated. FIG. 33 in panel 3300 illustrates a scoring for a driver in a car race. Such a panel may be presented to a player of a fantasy legend car race game in accordance with an aspect of the present invention.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims.

1. A method for playing a fantasy legend game in a sport by a user, comprising:
a processor on a server computer providing to a player of the fantasy legend game a menu on a display of a client computer to draft for a fantasy legend team a plurality of players that includes at least one legend player from a list of a plurality of legend players stored in a memory, wherein each legend player is a player with a record of a plurality of played games in the past;
the processor accepting the at least one legend player selected on the menu;
the processor determining that a complete fantasy legend team has been selected in accordance with a rule of the fantasy legend game;
the processor assigning a score to the complete fantasy legend team, based on at least an individual score of the at least one legend player, wherein the individual score of the at least one legend player is determined from a performance of the at least one legend player in a game in the plurality of played games in the past, wherein the game in the plurality of played games in the past is selected by the processor from the plurality of played games by applying a random number.

2. The method of claim 1, wherein the complete fantasy legend team includes players who are active as professional players in the sport.

3. The method of claim 1, further comprising:
the processor, before a winner of the fantasy legend game is determined, determining and displaying on a display the individual score of the at least one legend player and enabling a swapping of the individual score by selecting a new scoring game.

4. The method of claim 3, further comprising:
the processor requiring a compensation from the user before the individual score is provided.

5. The method of claim 3, wherein the processor enables a single swapping.

6. The method of claim 3, wherein the fantasy legend team includes at least two legend players and the processor is configured to perform a swapping of the at least two legend players.

7. The method of claim 3, further comprising:
the processor enabling the user to instruct the processor to generate a new individual score of the at least one legend player that is determined from a performance of the at least one legend player in another game played in the past.

8. The method of claim 1, wherein the random number is generated by a random number generator with a uniform probability distribution.

9. The method of claim 1, wherein each member of the complete fantasy legend team is a legend player.

10. The method of claim 1, wherein at least one member of the complete fantasy legend team is a legend player in a flex position, wherein the flex position is a team position selected from a plurality of eligible team positions.

11. The method of claim 1, wherein a salary cap for the fantasy legend game is related to a number of legend players in the complete fantasy legend team.

12. The method of claim 11, wherein the salary cap is modified by the processor in response to the user paying an amount of money.

13. The method of claim 1, wherein the user is part of a plurality of users, each of the plurality of users paying a fee to participate in the fantasy legend game.

14. The method of claim 13, wherein a portion of the paid fee is awarded to a winner of the fantasy legend game.

15. The method of claim 1, wherein the fantasy legend game is selected from the group of sports consisting of football, basketball, baseball, ice hockey, golf and car racing.

16. The method of claim 1, wherein the fantasy legend game is selected from the group of sports consisting of soccer, cricket, field hockey and horse racing.

17. A system to play a fantasy legend game in a sport by a user, comprising:
a memory, configured to store and retrieve data, including instructions;
a processor, configured to retrieve instructions from the memory to perform the steps:
providing to a player of the fantasy legend game a menu on a display of a client computer to draft for a fantasy legend team a plurality of players that includes at least one legend player from a list of a plurality of legend players stored in a memory, wherein each legend player is a player with a record of a plurality of played games in the past;
accepting the at least one legend player selected on the menu;
determining that a complete fantasy legend team has been selected in accordance with a rule of the fantasy legend game;
assigning a score to the complete fantasy legend team, based on at least an individual score of the at least one legend player, wherein the individual score of the at least one legend player is determined from a performance of the at least one legend player in a game in the plurality of played games in the past, wherein the game in the plurality of played games in the past is selected from the plurality of played games by applying a random number.

18. The system of claim 17, wherein the complete fantasy legend team includes players who are active as professional players in the sport.

19. The system of claim 17, further comprising:
the processor, before a winner of the fantasy legend game is determined, determining and displaying on a display the individual score of the at least one legend player and enabling a swapping of the individual score by selecting a new scoring game.

20. The system of claim 19, further comprising:
the processor requiring a compensation from the user before the individual score is provided.
